(19) United States
(12) Patent Application Publication
(10) Pub. No.: US 2025/0378341 A1
(43) Pub. Date: Dec. 11, 2025

(54) System and Architecture for Continuous Generative Creation and Improvement of Specialized Small Parameter AI Models

(71) Applicant: Accretive Technology Group, Inc., Seattle, WA (US)

(72) Inventors: Jordan Washburn, Louisville, CO (US); Greg Spillane, San Diego, CA (US)

(21) Appl. No.: 19/228,522

(22) Filed: Jun. 4, 2025

Related U.S. Application Data
(60) Provisional application No. 63/658,774, filed on Jun. 11, 2024.

(51) Int. Cl. G06N 3/0895

(52) U.S. Cl. CPC G06N 3/0895

(57) ABSTRACT

A system, apparatus, and method directed to enabling users to create and improve a specialized form of large language model having fewer parameters and requiring fewer resources to train. Such specialized small parameter AI models may be used to perform or assist in performing a specific task or function within a specified domain.

### CROSS REFERENCE TO RELATED APPLICATION

This application claims the benefit of U.S. Provisional Application No. 63/658,774, entitled “System and Architecture for Continuous Generative Creation and Improvement of Specialized Small Parameter Language Models,” filed Jun. 11, 2024, the disclosure of which is incorporated, in its entirety (including the Appendices) by this reference.

### BACKGROUND

Generative artificial intelligence (AI) techniques are being applied to many different use cases and in different contexts. These techniques (such as GPT, ChatGPT, LLamA, Stable Diffusion, or Midjourney) are used to generate or assist in generating text, images, or other forms of content. Generative AI models learn the patterns and structure of the input training data and then generate new data that has similar characteristics. Some generative AI models are referred to as large language models (LLMs), which is a category of machine learning (ML) models associated with a relatively large set of training data, and relatively higher training time and computational cost. The result of the training process is a model that can be used to conduct a conversation, create images or video, or assist a user to perform a task (as non-limiting examples).

However, one disadvantage of conventional approaches to using generative AI techniques (specifically LLMs) is the relatively high cost and training time, which may not be productive if the LLM is being trained for a narrower task and/or within a specific domain. This is often the result of such models having numerous adjustable parameters and being trained on a large dataset or corpus (which itself may require extensive time to label or annotate for training purposes). In general, such LLMs and uses have one or more of the following disadvantages:
they use an exorbitant amount of resources (computational cycles or processor time, memory, and input data for training);
they take a very long time to train/update and may become out of date quickly; and
they often do not perform well with complex tasks, especially in specialized fields.
   Although it is possible to create distillations from these larger models that can be more efficient, unfortunately the specialized distillations are often still general models that cover the topics of the larger model. As a result, it can be challenging for both language and image models to develop a small parameter model that is as good at an individual task as a distillation, as those are typically the same as the original general model only smaller. This results in a distillation executing more quickly but still being limited in its specialization due to limited training data, and hence in its application to a narrower field or use.

Embodiments of the systems, apparatuses, and methods disclosed herein are directed to solving these and related problems individually and collectively. As a non-limiting example, in some embodiments, a distillation may be leveraged and continuously fine-tuned to produce a model that has performance and utility that exceeds the distillation and, in some cases, a larger initial model.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments are directed to a system architecture and associated processing flow for creating and improving a specialized form of artificial intelligence (AI) model having fewer parameters and requiring fewer resources to train. The disclosed technique may be used to train multiple types of specialized models including (but not limited to) vision models, image models, language models, video models, and voice models. Such specialized AI models (as they are referred to herein) may be used to perform or assist in performing a task or function within a specified and typically narrow domain. Although more limited than a general large language model (LLM) or machine learning (ML) model, a specialized small parameter language model may be more applicable to a task and require less computational resources and memory to produce (e.g., train) and maintain. Similarly, small parameter image models may be better at producing high quality outputs for a subset of image types or styles (e.g., realistic styles, product photography, or specific characters) at the sacrifice of being good at a larger range of characteristics. The same concepts apply broadly to all of the types of AI models that may be generated using the disclosed approach which creates a “specialist” for a language, vision, video, or voice task by using techniques for targeted and precise dataset creation.

Embodiments of the disclosed system architecture may comprise multiple data processing pipelines that (a) operate in real-time to process data as it becomes available, (b) operate concurrently in that each is being executed at substantially the same time, and (c) operate continuously in that each is being executed without interruptions to ensure the availability of updates and integration of improvements into the resulting models.

Embodiments of the disclosed small(er) parameter AI models have a significantly smaller amount of base data and can be trained regularly (e.g., nightly) and run using fewer computational resources. Additionally, they can be trained using a limited set of specialized data and a process that utilizes a dynamic processing pipeline to provide model improvement(s). The smaller models perform significantly better at complex tasks; one can create “expert” models that are capable of performing a task such as “typescript react developer” and then iterate on the model to keep it up to date with new information, improve its ability to handle the complex task, and use it alongside other expert systems or applications to collaborate on more complex multi-functional problems. The smaller image, video, and voice models can perform significantly better at specialized tasks such as representing a character (e.g., a specific person or avatar) in a specific and dynamic setting, and with greater realism.

Embodiments provide a pipeline for the development and continual improvement of expert-level small parameter AI models and include a capability for performing “data shaping.” Data shaping involves the intentional definition and structuring of a dataset to ensure that it more completely matches the needs of a model or task, thereby optimizing model performance and adaptability. This approach to crafting datasets, combined with synthetic data generation and iterative refinement processes, enables more precise control over model behavior without increasing its complexity.

Embodiments of the disclosure are directed to systems, apparatuses, and methods for creating and improving a specialized form of language or image model having fewer parameters and requiring fewer resources to train. Such specialized small parameter AI models (as they are referred to herein) may be used to efficiently perform or assist in performing a specific task or function within a specified domain.

The disclosed and/or described “Train as you go” framework advances the development of small parameter models through a structured approach centered on data shaping tailored to specific use cases. The intention behind “train as you go” is eventual perfection—which means to continuously expand, improve, and shape/select datasets to create a better model and improve it on a regular basis.

In one embodiment, the disclosed technique uses an AI agent in the loop and a human in the loop to expand and improve a model being developed. The agent is primarily responsible for identifying gaps in a model's training dataset in terms of both quantity of data and quality of data and then creating synthetic data representations from other larger models. This effectively serves to transfer competency over from the larger model to the smaller one.

A human in the loop is in charge of data quality review, modifying the data to improve it (e.g., this might include cropping or rewriting), captioning, and providing feedback to the agent on what data needs to be generated next. The human's primary job is to evaluate data quality by comparing synthetic data to data that is similar (as determined by a suitable similarity metric, such as vector distance). The disclosed model development framework selects the highest quality data and progressively discards lower quality data. This approach helps to ensure that each model is trained on ever-improving datasets that are more optimally suited to its operational demands or requirements, thereby significantly enhancing both efficiency and effectiveness.

In one embodiment, searches and/or generative AI techniques are used to create information that may be used as a source of training data for a small parameter AI model. In one embodiment, a set of processes or software implemented tools are provided to enable a user to create, train, and refine such a model by performing one or more of the following steps, stages, methods, processes, operations, or functions:
Bootstrapping Phase:
   Information Gathering-defining specific requirements and constraints for a use case to help tailor data collection or synthetic data generation processes;
      This stage assists in identifying resources (articles, documents, how-to descriptions, explanations generated by experts, definitions, text generated from a video or audio, images, video, or voice samples of a character as non-limiting examples) that may be used to generate documentation describing how to perform a task described by a desired end-result, purpose, or goal (where the end-result, purpose, or goal may be expressed in a prompt to a generative AI technique or model);
      In one embodiment, a curation pipeline may be used to refine the set of resources by incorporating “expert” knowledge, character features, or filtering, as example processes;
   Data Shaping—this involves “shaping” data to align it with the model being developed and its defined requirements, thereby better ensuring each data element is purposeful and relevant;
      In the context of the disclosure, data shaping refers to a process or processes that operate to define the breadth and depth of topics or information that one of skill in a field would be expected to know to properly perform a task (see FIG. 1(d) for one way of representing this process flow);
   Training Data Generation—this is a driver behind “train as you go” and achieving eventual perfection, as described herein. Even when starting with relatively low-quality data for the first small parameter models, an agent works with other larger models to create properly formatted synthetic datasets that mimic real-world scenarios relevant to the use case or task and thereby refine the model's training dataset. For images, videos, and voice sources this means creating artifacts that represent a character (as an example), and for language models this means continuing to expand the intention or goal of a model, whether it be for purposes of reasoning, classifying, or providing expert knowledge;
      As mentioned herein, in one embodiment, this may include a process that provides additional or more nuanced instructions as context for the purpose, intended use, or functions performed by a trained model—this may assist in focusing the process of developing training data on specific use cases or capabilities of a model;
   Instrumentation of Training Data—instrumenting training data programmatically helps the system to determine data diversity so that one can properly select high quality and diverse data without expanding the dataset. This enables the approach to leverage humans as quality determiners and does not require them to handcraft the dataset. To do this, the system may employ NLP techniques such as clustering and/or vectorization (e.g., embeddings) to enhance the utility and applicability of the generated synthetic data;
      In some embodiments, this step or stage is a form of concept clustering to ensure diversification of data. Metadata may also be clustered, and quality scores for data may be recorded to maintain an audit history;
Continual Learning and Adaptive Response Mechanism Phase:
   Model Training and Continuous Evaluation—the disclosed small parameter models train on both the initially shaped/selected data and dynamically generated synthetic data, undergoing regular evaluations to assess performance and identify any emergent gaps in data coverage or functionality;
      In one embodiment, this may include creating an instruction set from an output of an LLM using an instruction pipeline-in some embodiments, the generated instruction sets may include instructions for one or more of training, validation, or evaluation of a model;
      In one embodiment, this may include determining that model performance is not adequate and that additional training data may be useful. In such a situation, a “reasoning” agent or model may be used to suggest or generate additional data. In some cases, this additional data may be more “diverse” data that exhibits a greater variety in characteristics or content (as non-limiting examples). For example, this may occur in the following situations;
         When an area is performing poorly and would benefit from additional training data, a user can work with a reasoning agent or model to plan out (and in some cases, generate) the new data. As one example, this might occur in a situation where certain images have deformities. In this case, a user may obtain a set of diverse prompts from a reasoning agent or model and generate a set of synthetic data to augment the training data. Similarly, if a certain communication flow is leading to a negative experience, then one could create synthetic conversations that handle it better;
         When the clustering process identifies gaps, then the reasoning agent can generate new data on its own;
         When a concept is flagged as difficult and there is not enough training data, then the reasoning agent or model can generate new data on its own;

In one sense, the situation is that a created small parameter model is performing poorly when presented with current data, so one wants to try using more diverse data that is similar to the current data. In one embodiment, an agent or model is presented with examples of the current data and asked, “what new data should be created?”. The agent comes up with suggestions, the new data is created and then evaluated as training data. If it is an improvement, it can be added to an existing training dataset.

Regarding implementation of such a reasoning agent or model, in some embodiments, a reasoning model can be a transformer or diffusion/transformer hybrid language model that is focused on reasoning. Use of such an agent or model provides a method of taking a set of data and information (e.g., inputs having to do with a topic, how well a target model (which can be any AI model) performs with regards to a topic, the set of training data that the model was trained on, the specific training data related to the topic that the model was trained on, overall analytics on the training data, and specific analytics on the topic of interest. The reasoning agent or model uses the data and information to determine the types of data it needs to improve performance and suggests prompts to create the desired synthetic data. From that point, one can either use those prompts and create synthetic data, search for and find additional real data, or use other synthetic data to increase the available training data.
Prompt Analysis and Adaptive Forwarding—leveraging the data instrumentation functionality, the process may analyze incoming prompts to assess whether the created small parameter model is capable of responding and/or responding appropriately to the prompt;
   If a prompt is beyond the model's current capabilities, it may automatically be forwarded to a larger, more capable model;
   Concurrently, this may trigger a process to augment or refine the training dataset to equip the small parameter model with the necessary knowledge for handling similar queries more effectively in the future;
Evaluate a trained small parameter model;
   This typically comprises use of an evaluation instruction set to evaluate the trained model and identify topics where additional resources would be beneficial, and if so, return control to the information gathering phase or stage;
   In some embodiments, this may include an evaluation process that includes human (e.g., subject matter expert) review.

In one embodiment, the disclosure is directed to a system, apparatus, and method to enable users to create and improve a specialized form of model having fewer parameters and requiring fewer resources to train. Such specialized small parameter AI models (as they are referred to herein) may be used to perform or assist in performing a task or function within a specified domain. The system or apparatus may include a set of computer-executable instructions stored in a memory or data storage component (such as one or more non-transitory computer-readable media) and one or more electronic processors or co-processors. When executed by the processors or co-processors, the instructions cause the processors or co-processors (or a device of which they are part) to perform a set of operations that implement an embodiment of the disclosed method or methods.

In one embodiment, the disclosure is directed to a set of computer-executable instructions stored in (or on) one or more non-transitory computer-readable media, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed and/or described herein may provide services or functionality through a SaaS or multi-tenant platform. The platform provides access to multiple entities, each with a separate account and associated data storage. Each account may correspond to a specific task, a category of tasks, a source of information, a set of sources or resources relevant to a task or category of tasks, a domain or sub-domain in which the disclosed small parameter model may be used, or an organization, as non-limiting examples. Each account may access one or more services, a set of which are instantiated in their account, and which implement one or more of the methods or functions disclosed and/or described herein.

Other objects and advantages of the systems, apparatuses, and methods disclosed and/or described herein may be apparent to one of ordinary skill in the art upon review of the detailed description and the included figures. Throughout the drawings, identical reference characters and descriptions indicate similar, but not necessarily identical, elements. While the embodiments disclosed and/or described herein are susceptible to various modifications and alternative forms, specific embodiments are shown by way of example in the drawings and are described in detail herein. However, embodiments of the disclosure are not limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) is a flow diagram illustrating a set of processes, operations, or functions that may be used to generate a set of resources for use in training a small parameter AI model, specifically for performing a breadth-first topic gathering, when implementing an embodiment of the disclosure;

FIG. 1(b) is a flow diagram illustrating a set of processes, operations, or functions that may be used to perform a depth exploration process and to organize (cluster) the content in the generated resources, in accordance with an embodiment of the disclosure;

FIG. 1(c) is a flow diagram illustrating a set of processes, operations, or functions that may be used to create and evaluate content, and if needed, expand upon the content in the generated resources, in accordance with an embodiment of the disclosure;

FIG. 1(d) is a flow diagram illustrating a set of processes, operations, or functions that may be used to perform a data shaping phase, in accordance with an embodiment of the disclosure;

FIG. 1(e) is a flow diagram illustrating a set of processes, operations, or functions that may be used as part of prompt analysis and adaptive forwarding to generate and use a set of training data for a model, in accordance with an embodiment of the disclosure;

FIG. 2 is a diagram illustrating elements or components that may be present in a device, apparatus, server, platform, or system configured to implement a method, process, function, or operation in accordance with an embodiment of the disclosure; and

FIGS. 3-5 are diagrams illustrating an architecture for a multi-tenant or SaaS platform that may be used in implementing an embodiment of the systems and methods disclosed herein.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter are described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that the disclosure will satisfy the statutory requirements and convey the scope of the disclosure to those skilled in the art.

Among other forms, the subject matter of the disclosure may be embodied in whole or in part as a system, as one or more methods, or as one or more apparatuses or devices. Embodiments may take the form of a hardware implemented embodiment, a software implemented embodiment, or an embodiment combining software and hardware aspects. For example, in some embodiments, one or more of the operations, functions, processes, or methods disclosed and/or described herein may be implemented by a suitable processing element or elements (such as a processor, microprocessor, CPU, GPU, TPU, QPU, state machine, or controller, as non-limiting examples) that are part of a client device, server, network element, remote platform (such as a SaaS platform), an “in the cloud” service, or other form of computing or data processing system, apparatus, device, or platform.

The processing element or elements may be programmed with a set of executable instructions (e.g., software instructions), where the instructions may be stored on (or in) one or more suitable non-transitory computer-readable data storage elements. In some embodiments, the set of instructions may be conveyed to a user over a network (e.g., the Internet) through a transfer of instructions or an application that executes a set of instructions.

As mentioned, in some embodiments, the systems and methods disclosed and/or described herein may provide services or functionality through a SaaS or multi-tenant platform. The platform provides access to multiple entities, each with a separate account and associated data storage. Each account may correspond to a specific task, a category of tasks, a source of information, a set of sources or resources relevant to a task or category of tasks, a domain or sub-domain in which the disclosed small parameter model may be used, or an organization, as non-limiting examples. Each account may access one or more services, a set of which are instantiated in their account, and which implement one or more of the methods or functions disclosed and/or described herein.

In some embodiments, one or more of the operations, functions, processes, or methods disclosed and/or described herein may be implemented by a specialized form of hardware, such as a programmable gate array, application specific integrated circuit (ASIC), or the like. Note that an embodiment of the disclosed methods may be implemented (in whole or in part) in the form of an application, a sub-routine that is part of a larger application, a “plug-in”, an extension to the functionality of a data processing system or platform, or other suitable form. The following detailed description is, therefore, not to be taken in a limiting sense.

Large language models (LLMs) are known for their sophisticated handling of complex data, excelling in tasks that necessitate an understanding of vast and diverse datasets. They are capable of generating coherent, contextually appropriate responses across various domains. However, the deployment of LLMs in real-time applications faces challenges, primarily due to significant computational demands, scalability challenges, latency issues, and connectivity requirements. Similarly, conventional image models, video models, and voice models can generate highly diverse data and may excel in generating broad and generalized concepts but may have limitations when applied to narrower tasks or specialized domains.

In contrast, “small” (or smaller) parameter models are designed for and capable of rapid specialized processing and can operate in a more scalable manner. Although their smaller size and limited computational power may restrict their performance in complex tasks relative to conventional models, many of the benefits of conventional models can be obtained and even exceeded for specific tasks with the proper training and focus. Similarly, with image models, video models, and voice models, embodiments are able to achieve higher quality, greater character consistency, and lower latency by leveraging smaller models that are “experts” with regards to a given character, avatar, or representation.

In the context of this disclosure, a “small” parameter LLM may be considered to be a model with fewer parameters or computational units than conventional Large Language Models (LLMs) such as GPT-4, Claude2, and Bard. As an example, while conventional LLMs might contain 175 Billion and up to Trillions of parameters, “small” models may contain between 3 Billion and 40 Billion (as a non-limiting example of this category of models). These smaller models may be tailored for specific tasks, making them more efficient in their specialized domain, as well as easier and less expensive to produce and operate. Because of their size the small(er) models can be run (executed) significantly faster and on a single machine or system (and in some cases, even a mobile device) in contrast to large models that typically require significant computing power.

The disclosed and/or described “Train as you go” framework advances the development of small parameter models through a structured approach centered on data shaping tailored to specific use cases. This strategy helps to ensure that each model is trained on datasets optimally suited to its operational demands and task, thereby significantly enhancing both the efficiency and effectiveness of the model development process.

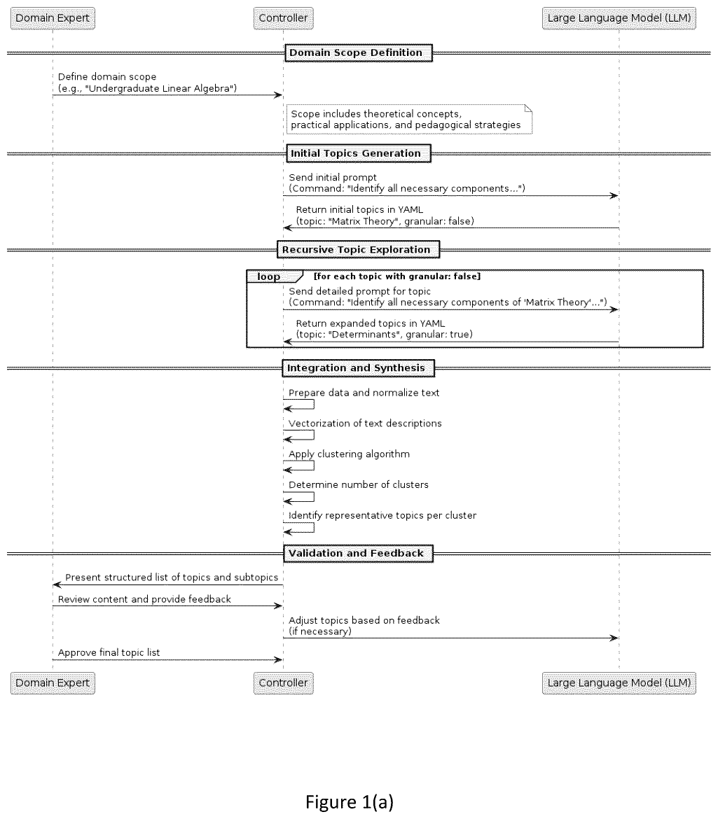

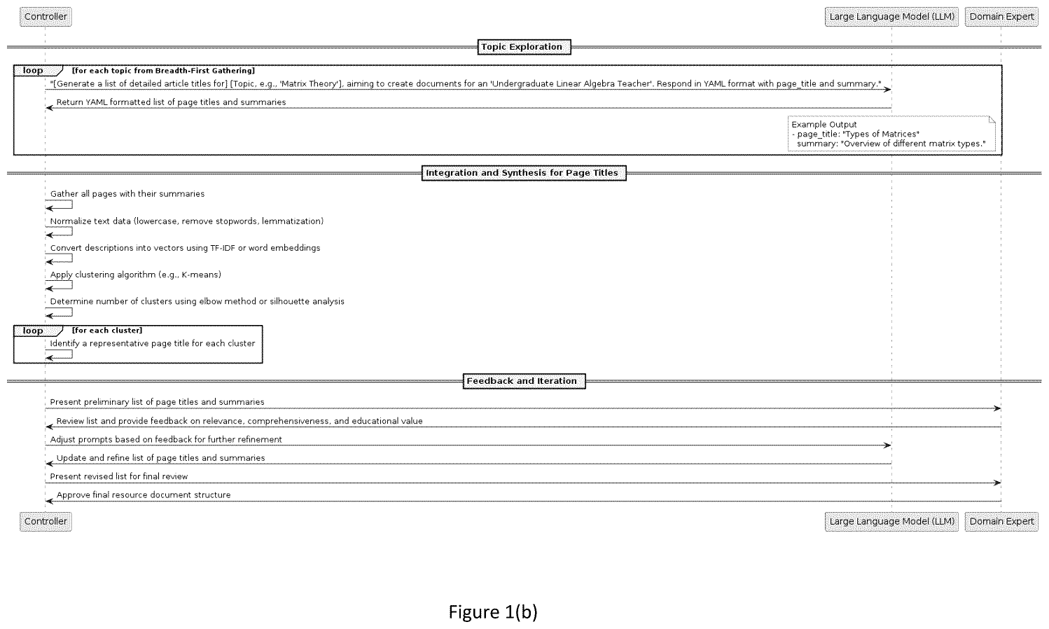

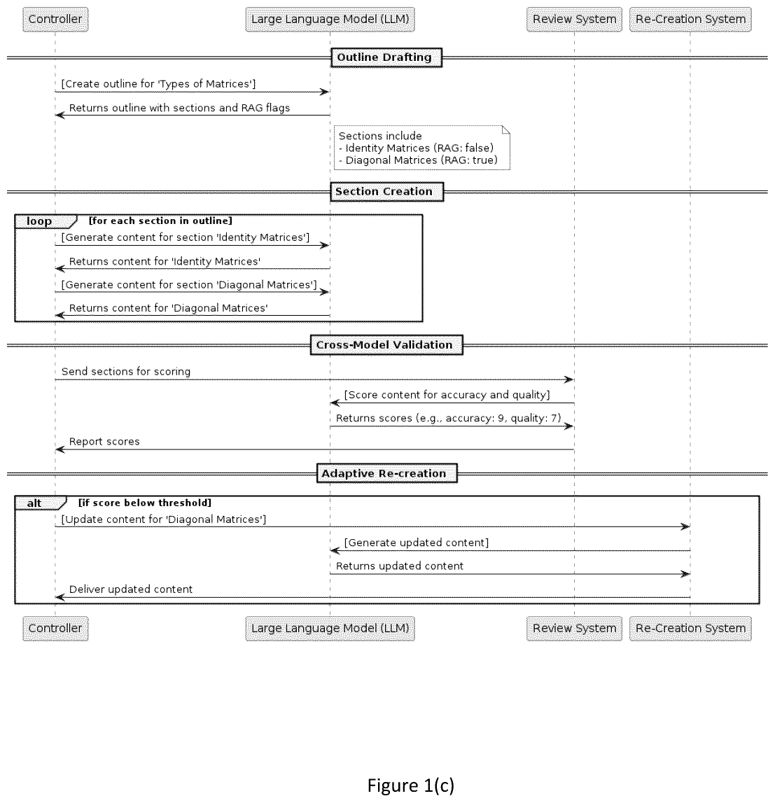

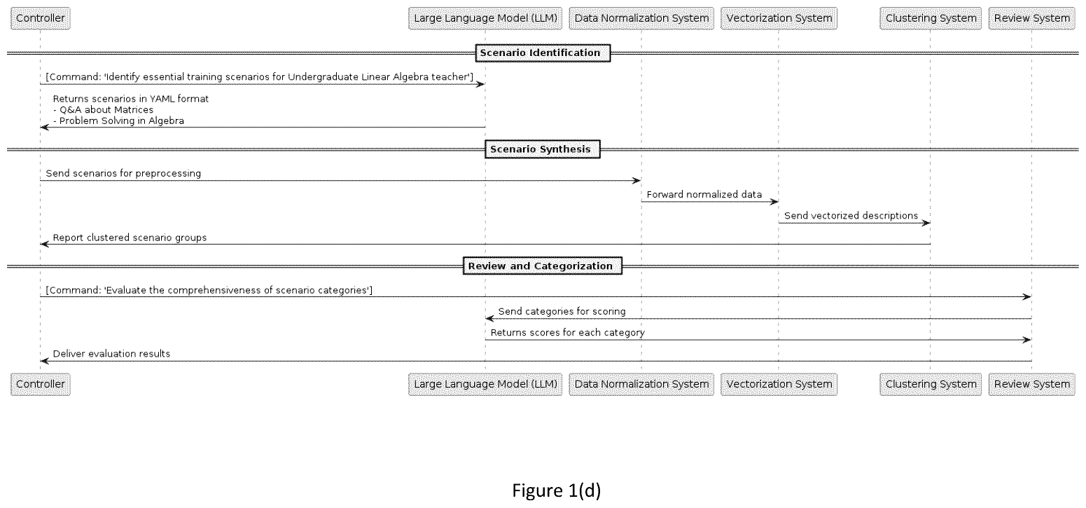

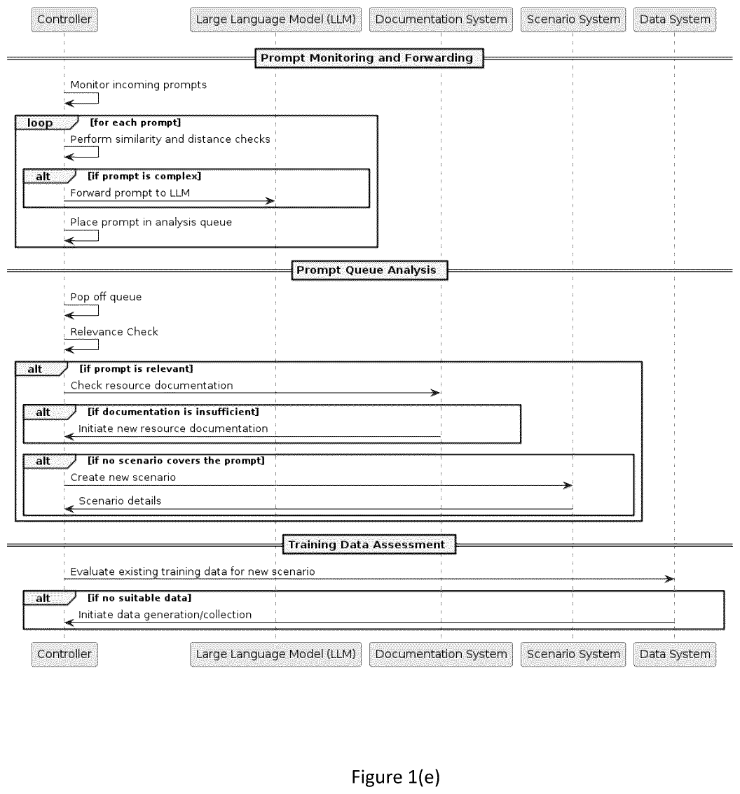

As mentioned, in the context of the disclosure, data shaping may include determining what data or information would be expected to be needed to accomplish a specific task or goal, taking into consideration the type of model being developed. This may be followed by determining scenarios of interest for using the model, and identification of useful information for developing training data for the model. FIG. 1(d) is a flow diagram illustrating an example of the data shaping process flow.

The disclosed and/or described approach introduces a framework for developing small parameter models that emphasizes continuous adaptation and proactive data management or data shaping. A primary approach behind this process flow is categorizing the data into “concepts” and then creating observations about the data. For images, a concept might be a specific character or avatar, and the observations might mean describing the character, the pose, and specific attributes. For language, the concept might be something like “reasoning about system architectures” and the observations might mean describing the system, the architecture, the purpose, and the level of depth of the desired response. This approach and its constituent operations or functions may be utilized in tandem with traditional edge model training methodologies that focus on architecture optimizations and training strategies.

In some embodiments, the disclosed and/or described approach may be implemented by performing one or more of the following processes:
Intentional Data Shaping-data is specifically shaped (i.e., defined, identified, acquired) to align with model requirements, thereby increasing relevance and efficiency for targeted use cases. To do this, embodiments use both observations and vectors from the data itself. The concepts and observations help to classify the data so that data sampling results in a diverse set across multiple concepts. The vectors help to ensure the process does not overfit. The quality score from a human in the loop helps to remove lower quality data as the process continues;
Two-Step Synthetic Data Utilization—initially, the process generates resource documentation from both real and synthetic data. Subsequently, it produces training data for a model that is specifically tailored to the operational use case, thereby enhancing flexibility and applicability;
   As described in greater detail herein, in one embodiment, this may include a process that provides additional or more nuanced instructions as context for the purpose, intended use, or functions performed by a trained model—this may assist in focusing the process of developing training data on specific use cases or desired capabilities of a model;
Advanced Instrumentation Techniques—synthetic data are refined (e.g., modified or corrected) using instrumentation that may include vector databases, enabling a more nuanced analysis and improved training outcomes that are better aligned with operational needs;
Continuous Improvement Cycle—the disclosed and/or described framework operates on a continuous cycle of evaluating and enhancing data quality and model performance. This includes custom synthetic data evaluations to identify and address training data or functionality gaps;
Real-Time Adaptation to Input Variability—the framework and approach dynamically adjusts to new information, an aspect that is believed crucial for handling the unpredictable variability of data inputs in edge environments; and
Custom Evaluation and Strategic Gap Analysis—tailored evaluation mechanisms are used to assess model performance and identify data or processing deficiencies. Strategic adjustments are made based on these insights to maintain a model's effectiveness and relevance.

In some embodiments, the disclosure is directed to a comprehensive system architecture and processes that leverages a multi-pipeline approach to result in the creation and improvement of specialized small parameter models capable of performing expert level complex tasks within specific verticals while using minimized resources. As disclosed, embodiments of the system architecture may comprise multiple data processing pipelines that (a) operate in real-time to process data as it becomes available, (b) operate concurrently in that each is being executed at substantially the same time, and (c) operate continuously in that each is being executed without interruptions to ensure the availability of updates and integration of improvements into the resulting models.

In one embodiment, the disclosed architecture comprises the following structures, components, elements, operations, functions, or processes:
Specialized Small Models—the system designs and creates small parameter models that are tailored for specific tasks or verticals. Since these models are not intended to be general purpose, they can be made more compact and efficient, thus requiring less computational power and memory;
Implementation of a Multi-Pipeline approach;
   Data Creation Pipeline—for language models, this utilizes a combination of commercial LLMs and curated proprietary information to identify and/or generate specific resources (i.e., sources of data for use in training a model). By using a mix of general and specialized data sources, the system can achieve a balance between breadth and depth without the need for the relatively vast amounts of resources used in conventional approaches to developing a trained LLM (as illustrated in FIGS. 1(a) and 1(b));
      For asset (i.e., image, video, or audio) models, this follows the same process with a difference being that it utilizes a combination of open-source models to generate assets along with curated proprietary assets;
   Instruction Generation Pipeline—transforms the resources (e.g., accessed or created documentation) into sets of prompts and answers (or other format) suitable for use in fine-tuning a model. This focuses the training process on specific topics, providing greater efficiency and applicability of the model to performance of a desired task;
   Model Generation Pipeline—this takes the fine-tuning instruction(s) and applies them to base models to create a specialized small parameter model. By continuously and iteratively evaluating and fine-tuning, the disclosed and/or described system helps ensure the models remain efficient and up to date without needing to retrain a model from scratch;
Continuous (on-going) Iterative Improvement—rather than retraining a model entirely from scratch, the system focuses on iteratively improving an existing model. This approach reduces the computational resources and memory needed to produce an AI model tuned to a specific task.

In one embodiment, a specific task and/or vertical for which a small parameter trained AI model is to be used is identified. This assists in identifying an appropriate corpus of documents or other sources for generating training data for the model. As a non-limiting example, a task, vertical, or character (e.g., an avatar) to which the disclosed approach is to be applied may be determined (or characterized/represented) by consideration of one or more of the following:
Adaptability and Reconfigurability—embodiments of the disclosed system can cater to multiple industries and needs. In one embodiment, the disclosed system and methods may evaluate the potential of a vertical based on the specificity and complexity of tasks that could be better addressed by a specialized model rather than a general one. As a non-limiting example, this evaluation process may be implemented by a set of steps, stages, functions, processes, or operations such as one or more of the following:
   Start with a general prompt such as: “I want to create a LM (language model) that specializes in modern semantics and is intended to: “Decipher the neural mechanisms behind the use of idiomatic expressions across languages”;
      The process is essentially the same for asset (i.e., image, video, or audio) models—here a general prompt might take the form of “I want to create an image model that specializes in creating a character that matches these precise attributes (and this exact face)”;
   Use one or more large language models (LLMs) to generate an array of 200 topics believed to be required knowledge to be proficient in that space, technical area, or environment;
   Evaluate those topics and create an array of 200 subtopics for each topic (again using one or more LLMs);
   Write/generate resource documentation for each topic, essentially a PDF describing it at an “expert” or at least experienced practitioner level;
   Pull apart the resource documentation and create instruction sets (ideally, relatively complex instruction sets geared towards problem solving);
      This refers to a process that “deconstructs” the resource documents into a set of If . . . , then . . . types of “instructions” (as non-limiting examples of the form of such instructions) that cover the typical information, explanations, situations, or “hints” that would be of value to someone learning about a situation; and
   Use those instruction sets to train a small parameter model;
      The information gathering (depth & breadth) and training data generation phases are used to collect background information and use that to generate training data in a form similar to how a conversation with an expert would progress, as those phases are primarily directed to gathering information expected to be known and understood by a domain “expert”;
      Define the broad topic(s);
      Within each topic, define the important parts or subjects;
      More precisely define the information desired for each important part;
   As further examples, if one was training a medical model for end users, the instructions would be directed to triaging an issue and providing advice;
   Similarly, If training a medical model for researchers, the instructions would be directed to explaining facts and generating “ideas”;
Specific Use Cases and Examples—non-limiting examples of tasks or verticals to which an embodiment of the disclosed and/or described approach may be applied include executive coaching, specialized care management, language education for children, character consistency, character generation, and financial analysis. These are areas where a tailored approach, based on specific data and methodologies, is expected to be more beneficial and efficient than using a broad, general-purpose model. As background, see “WizardLM: Empowering Large Language Models to Follow Complex Instructions”, which addresses some of the issues involved, https://arxiv.org/pdf/2304.12244.pdf.

In general, by leveraging large language models (LLMs), proprietary data, and the separation of pipeline functions (i.e., isolation or specialization of processing tasks), embodiments facilitate the relatively rapid creation and iteration of small expert-level models that are more capable and up to date than the large best-in-class general models.

The disclosed and/or described system's adaptability and reconfigurability allow it to create specialized models across multiple industries and domains. Non-limiting examples of use cases or contexts in which such a small parameter LLM might be beneficial include the following:
Executive Coaching—customized models can be developed to aid in executive coaching, understanding specific leadership principles, industry trends, and personal development strategies that align with the goals and culture of a particular organization or an individual leader;
Specialized Care Management—models tailored for healthcare providers can assist in managing patient care, from chronic illness monitoring to personalized treatment planning;
Language Education for Children—custom models specifically designed to teach Spanish (or another language) to English-speaking children aged 3-8 using methodologies aligned with their learning capabilities;
   As a non-limiting example, construction of this type of model might involve one or more of the following functions or considerations:
      A way to evaluate where a child is at with regards to language comprehension and develop a curriculum and goals, then using the curriculum to trigger interactive lessons with a voice they're familiar with (such as a family member);
      Teaching a subject or concept through generative story telling using voices of family members, and derived artwork;
         A benefit of this approach will be from directly understanding the input from the child at a more personalized level than obtained using a ruleset, and more customized engagement where the child is (more) responsible for the direction of a lesson and learns through exploration;
Financial Analysis—custom models for interpreting intricate financial data, aiding in investment decisions or risk assessment within a particular market sector, or for an investor with a particular risk profile.

### Data Creation

In some embodiments, the disclosed Data Creation Pipeline or process flow is a core feature of the system's information gathering capabilities. Utilizing both commercial large language models (LLMs) and curated proprietary information, it generates a set of resources, tagged (e.g., labeled) and categorized to provide information about specific topics and subtopics. This structure allows for regular updating and fact-checking, thereby ensuring that the generated models remain viable and effective. In some embodiments, to expedite the generation of a training dataset, the Data Creation Pipeline may utilize a form of programmatic labeling by leveraging the capabilities of LLMs to tag and categorize resources automatically. In one embodiment, the labeling function or operation may combine automated/programmatic tagging with human verification or curation to ensure greater accuracy and relevance.

Further, and as described in greater detail, in one embodiment, this may include a process that provides additional or more nuanced instructions as context for the purpose, intended use, or functions performed by a trained model. This may assist in focusing the process of developing training data on specific use cases or capabilities of a desired model.

### Information Gathering

Information Gathering is a foundational phase in the bootstrapping process of the disclosed and/or described “Train as you go” methodology. This step involves a comprehensive and systematic collection and creation of domain-specific documents, which are used for the creation of precisely tailored model training datasets.

### Breadth Exploration

The Breadth Exploration phase canvasses a domain to capture aspects believed necessary for a comprehensive understanding of the subject matter or task under consideration. Below is a description of the entities and processes that may be employed during this phase:
Entities:
   Domain Expert—the domain expert is responsible for providing expert knowledge and definitive guidance on the scope and boundaries of the domain being explored. This individual ensures that aspects of the domain that are relevant to the model's training and applications are considered and accurately represented;
      In some cases, a trained model may be used to perform this knowledge and/or guidance (in whole or in part)—however, for a complex domain this may require extensive prompt engineering and the development of one or more related or derivative models that are trained to behave differently to demonstrate other ways of “reasoning” to a conclusion;
   Controller: the controller is an AI agent that acts as an intermediary between the domain expert and an AI model. It translates the domain scope and requirements into actionable tasks, executes those tasks, and manages the flow of information and data between the two. This component is important for coordinating the topic generation process and ensuring that the output aligns with the expert's specifications. The agent also builds batches of synthetic data for human review so that a human in the loop can review, possibly discard, and apply quality scores to data;
   LLM—the LLM is a large (e.g., 70 billion+ parameter) language model that is utilized for its capability to generate content based on the input received from the controller. It is used to produce a comprehensive list of topics and more detailed subtopics, ensuring that the breadth and depth of the domain are explored thoroughly and comprehensively.

FIG. 1(a) is a flow diagram illustrating a set of processes, operations, or functions that may be used to generate a set of resources for use in training a small parameter AI model, specifically for performing a breadth-first topic gathering, for use in implementing an embodiment of the disclosure:
Domain Scope Definition:
   Description—a Domain Expert defines the scope and key areas of the domain that need to be addressed and communicates these requirements to the Controller;
   Example—the domain could be specified as “Undergraduate Linear Algebra.”;
Initial Topics Generation:
   Controller's Action—the Controller formulates an initial prompt based on the Domain Scope and sends it to the LLM to generate a broad (er) list of initial topics;
   LLM Prompt (examples)—“[Command, e.g., ‘Identify all necessary components within the domain of’] [Domain scope input, e.g., ‘Undergraduate Linear Algebra Teacher’], [Response guidance, e.g., ‘focusing on key theoretical concepts, practical applications, and pedagogical strategies’]. [Response format guidance, e.g., ‘Respond in YAML format including attributes for topic name, description, and a granularity flag. A topic is marked ‘granular: false’ if it requires further expansion to reach the necessary level of detail.’]”;
   Example Output:
      topic_name: “Matrix Theory;”
      description: “Comprehensive exploration of matrices, including types, operations, and properties.”
      granular:false

Note that another approach to generating a list of one or more initial topics is by leveraging information provided by a domain expert-this may be in the form of a set of reference materials and/or asking an expert question(s) regarding materials to provide a foundation for understanding a topic. A trained LLM model may be used to supplement the information provided by such an expert.
Recursive Topic Exploration:
   Description—for each topic marked with granular: false, the Controller sends further detailed prompts to the LLM to expand these topics into more granular subtopics;
   LLM Prompt (examples)—“[Command, e.g., ‘Identify all necessary components within the domain of’] [Topic Name, e.g., ‘Matrix Theory’] as it relates to the [Domain Scope, e.g., ‘undergraduate linear algebra education’]. [Response guidance, e.g., ‘focusing on key theoretical concepts, practical applications, and pedagogical strategies’]. [Response format guidance, e.g., ‘Respond in YAML format including attributes for topic name, description, and a granularity flag. A topic is marked ‘granular: false’ if it requires further expansion to reach the necessary level of detail.’]”;
   Example Output:
      topic_name: “Determinants”
      description: “Detailed explanation of determinants, including methods of calculation and applications.”
      granular:true
Integration and Synthesis:
   Description—the Controller integrates the responses, merging related topics, clusters them, and then creates a discrete comprehensive list or record.
   Example Process:
      Prepare data:
         Gather all topics with their descriptions and any existing hierarchical relationships (i.e., parent_topic_id);
         Normalize text data for NLP processing (e.g., convert text to lowercase, remove stop words, apply lemmatization, as examples of possible processing);
      Vectorization:
         Convert text descriptions into numerical vectors using TF-IDF or word embeddings. This transformation is used to evaluate textual similarity and assist in performing clustering;
      Apply Clustering Algorithm(s):
         Use a clustering algorithm (K-means or Hierarchical clustering, as non-limiting examples) to group topics based on the similarity of their vectorized descriptions;
         Determine the number of clusters (using elbow method or silhouette analysis, as non-limiting examples) to ensure meaningful grouping without excessive granularity or overgeneralization;
      Identify Representative Topics
         For each cluster, identify a representative topic through an LM prompt—example command: “[Command, e.g., ‘Identify a central topic that represents all of the following topics [t1, t2, t3, t4’]”;
Validation and Feedback:
   Presentation to Domain Expert—the structured list of topics and subtopics is presented to the Domain Expert for validation;
   Feedback Process—the Domain Expert reviews the content for completeness and educational relevance, providing feedback which may include requests for further detail or refinement. Gaps are identified and filled using additional LLM queries, if necessary.

As a non-limiting example, the following steps or stages describe how a character might be generated. The generated images may be used to create a story, a video, or as part of interacting with a user (as examples):
Description—for the character “spiderman” (used purely as an example) the controller needs to generate more poses with spiderman shooting his web while flying in the air.
Image Prompts:
   Generate an image of spiderman swinging between New Tork City buildings shooting his web at another building;
   Generate an image of spiderman swinging in central park shooting his web at a tree;
   Generate an image of spiderman falling from a bridge shooting his web at a boat;
Example Outputs:
   60 image and caption pairs that a human can review, modify, approve/reject, and quality score.

Next, a depth exploration process flow is executed. The depth exploration flow refines the topics identified during the breadth-first topic gathering phase. For example, the depth exploration phase may create resource document page titles for each topic, with those used to generate content during a later phase.

In one embodiment, the content may be generated using a suitable generative AI technique, such as where a tuned prompt is fed into a trained LLM. The generated content may then be used as the basis for constructing training data for a small parameter AI model (subject to the additional process(es) for guiding the creation of training data disclosed and/or described herein).

FIG. 1(b) is a flow diagram illustrating a set of processes, operations, or functions that may be used to perform a depth exploration process and to organize (cluster) the content in the generated resources, in accordance with an embodiment of the disclosure. As an overview, the process flow for this phase may include:
Topic exploration:
   Controller's Action—the Controller iterates through the list of topics generated during the Breadth-First Topic Gathering phase. For each topic, the Controller initiates the creation of a detailed “skeleton” of page titles and/or sections that will later serve as the basis for generating comprehensive content;
   LLM Prompt—“[Command, e.g., Generate a list of detailed article titles that comprehensively cover the following topic] [Topic input, e.g., Matrix Theory’], [Domain Response guidance, e.g., ‘with the aim to create documents for training an ‘Undergraduate Linear Algebra Teacher’’. [Response format guidance, e.g. ‘Respond in YAML format including attributes for page title and summary]”;
   Example Output:
      page_title: “Types of Matrices”
      summary: “Detailed overview of different matrix types including identity, diagonal, and triangular matrices.”
Integration and Synthesis for Page Titles:
   Description—After gathering the initial list of page titles from the LLM, the Controller integrates the feedback and iteratively refines the titles. A goal is to ensure each page title accurately captures the essential elements of the topic and aligns with the educational goals;
   Process:
      Prepare data:
         Gather all generated pages with their summaries;
         Normalize text data for NLP processing: (e.g., convert text to lowercase, remove stop words, and apply lemmatization, as non-limiting examples)
      Vectorization:
         Convert text descriptions into numerical vectors using TF-IDF or word embeddings. This transformation is used to enable measuring textual similarity and performing clustering;
      Apply Clustering Algorithm(s):
         Use a clustering algorithm (e.g., K-means or Hierarchical clustering, as non-limiting examples) to group topics based on the similarity of their vectorized descriptions;
         Determine the number of clusters (using elbow method or silhouette analysis, as non-limiting examples) to ensure meaningful grouping without excessive granularity or overgeneralization;
      Identify Representative Pages:
         For each cluster, identify a representative topic through an LM prompt: “[Command, e.g., ‘Identify a single page title that represents all of the following topics [p1, p2, p3, p4’]”;
Feedback and Iteration:
   Presentation to Domain Expert—the preliminary list of page titles and summaries is presented to the Domain Expert;
   Feedback Process: the Domain Expert reviews the list for relevance, comprehensiveness, and educational value. Feedback may include requests for additional page titles, deeper coverage of certain topics, or clarification of existing summaries.

### Character Generation Example

The character generation example for asset creation follows the same process as described above, with the difference being that the generation focuses on concepts that do not have sufficient high-quality representation. As one example, in the gaming context assume someone wants to create a character and a tool such as stable diffusion is used to generate a character that is close to what is desired. However, maybe one or two small changes are desired for the character—for example, it is desired that the character hold a specific sword and in a specific resting position and swing the sword in a specific stance. In this example, a model would be trained on the desired sword, resting position, and stance as individual aspects.

A next phase or set of processes, functions, or operations are those involved in document creation. The document creation phase iterates through the page titles derived during the depth exploration to generate detailed and comprehensive content for each defined page title. FIG. 1(c) is a flow diagram illustrating a set of processes, operations, or functions that may be used to create and evaluate content, and if needed, expand upon the content in the generated resources, in accordance with an embodiment of the disclosure.

An overview of the process flow for this phase may include:
Outline Drafting
   Controller's Action—the Controller generates an outline for each document based on the refined page titles and summaries from the depth exploration phase. This outline identifies sections that may require support from Retrieval-Augmented Generation (RAG) to obtain further information, and those that do not;
   LLM Prompt: “[Command, e.g., ‘Create an outline for generating comprehensive content on’] [Page Title, e.g., ‘Types of Matrices’], [Response guidance, e.g., Domain scope reminder +summary]. [Response format guidance, e.g., ‘Respond in YAML including section title, prompt, and RAG necessity flag. Each section is marked ‘RAG: true/false’ based on the need for external data retrieval.’]”;
   Example Output:
      section_title: “Identity Matrices”
      prompt: “Provide an in-depth anaylsis of identity matrices, including their definition, properties,and applications in linear algebra.”
      RAG:false
      section_title: “Diagonal Matrices”
      prompt: “Detail the characteristics and uses of diagonal matrices within the context of matrix theory, including example calculations.”
      RAG:true
Section Creation:
   For each section defined in the outline, the Controller issues a prompt to an LLM to generate the content. The prompts are crafted to result in detailed and accurate content creation that is aligned with the document's purpose or needs;
      As an example, this may be performed through a combination of RAG and an LM “conversation”. There are multiple ways to do this, and as one example:
         1. extract search terms from the section in the outline;
         2. use an API to search authoritative and up to date domains for information on that section;
         3. extract all (or a relevant part) of the accessed information;
         4. create a comprehensive outline for the topic;
         5. for each part of the outline, use the resources retrieved and write a comprehensive passage; and
         6. for each passage, use another LM to cross check it and highlight any factual errors;
   LLM Prompt: “[Command, e.g., Generate comprehensive content for the following <section title> of <page title>], [Response guidance, e.g., Domain scope reminder+summary] [Rag guidance, e.g., “summary of information from RAG].”;
Cross-Model Validation:
   Review and Scoring—post-creation, each section undergoes a review process where different trained LLMs score the content for accuracy and quality on a scale from 1 to 10;
   LLM Prompt: [Command, e.g., ‘Score the following content for accuracy and quality on a scale of 1-10.’] [Response format guidance, e.g., ‘Respond in YAML including a value for accuracy and for quality’]”;
   Example Output:
      accuracy: 9
      quality: 7
   Adaptive Re-creation—if a section scores below a predefined threshold, a new LLM is tasked with re-generating the section based on the feedback and insights derived from the initial score(s);
   LLM Prompt: “[Command, e.g., Update the following content for out <section title> of <page title>article<previous section content>], [Response guidance, e.g., Domain scope reminder +summary] [Rag guidance, e.g., “summary of information from RAG].”

A data shaping (or reshaping) phase is then executed and iterates through the domain specific documents to generate scenarios that need to be covered to create the “best performing” (or a better performing) small parameter model. FIG. 1(d) is a flow diagram illustrating a set of processes, operations, or functions that may be used to perform a data shaping phase, in accordance with an embodiment of the disclosure.

As a non-limiting example of how to determine “best performing”, this term may refer to two different aspects—a model trained on the right data and through the right scenarios. For instance, a language model that acts as a FAQ/QA (frequently asked questions—Q and A) would be trained on prompt pairs of questions and associated answers. A language model trained for a completion task would be trained on prompt pairs that start and finish a sentence or thought. A language model trained to function as a product manager would be trained on a more complicated back and forth between multiple roles in which it responds to various thoughts, requests, or ideas. These limited examples illustrate the importance of defining the correct data for a domain, defining the desired scenarios for the domain, and then creating/organizing the information and data relevant to the domain and/or scenarios.

An overview of the process flow for this phase may include:
Scenario Identification:
   Controller's Action—the Controller iterates through the domain-specific documents and analyzes them to create a comprehensive list of scenarios that need to be considered to create training data;
   LLM Prompt—“[Command, e.g., ‘Identify essential training scenarios for’] [Domain model input, e.g., ‘Undergraduate Linear Algebra teacher”]. [Response format guidance, e.g., include a variety of scenarios that include question and answer, complex problem solving between multiple professions, instruction-based commands, . . . ] [Response format guidance, e.g., ‘Respond in YAML format listing scenarios with descriptions.’] “;
   Example Output
      scenario: “Question and Answer about Matrice”
      description: “Interactive Q&A session where basic to complex questions about matrice posed and answered, illustrating different types and properties of matrices.”
      scenerio: “Problem Solving in Algebra”
      description: “Story problems involving algebraic concepts and equations to demonstrate application in real-world situations.”
Scenario synthesis:
   Description—the Controller gets a list of the scenarios generated from the pages/documents, clusters them, and then creates a discrete and comprehensive list;
   Process:
      Prepare Data:
         Action: Collect all scenarios along with their descriptions from the generated output;
         Data Normalization: Convert text data to lowercase, remove stop words, and apply lemmatization (as non-limiting examples). This standardizes the text data, facilitating more accurate analysis and clustering;
      Vectorization:
         Action—convert normalized text descriptions into numerical vectors using techniques such as TF-IDF or word embeddings;
         Purpose: This transformation is used to measure or evaluate textual similarity and perform clustering;
      Clustering:
         Action—apply a clustering algorithm (e.g., K-means or Hierarchical clustering as non-limiting examples) to group scenarios based on the similarity of their vectorized descriptions;
         Determine Cluster Number—use methods such as the elbow method or silhouette analysis to decide the appropriate number of clusters. This ensures more meaningful grouping without excessive granularity;
Review and Categorization:
   Action—review the clustered scenarios to categorize them thematically (e.g., Basic Concepts, Advanced Problem Solving, or Instructional Methods, as examples);
   LLM Prompt: “[Command, e.g., ‘Evaluate the comprehensiveness of the following scenario categories for’], [Domain model input, e.g., ‘an Undergraduate Linear Algebra teacher’], [Response guidance, e.g., ‘Specify if additional scenarios are needed or if any category is overly represented.’] [Response format guidance, e.g., Respond in YAML format 1-10 score of how well covered it is.']”;
   Example Output:
      category: “Basic concepts”
      covered: 10
      category: “Advanced problem solving”
      covered: 7

A training data generation phase is then executed. This phase involves transforming the structured and clustered scenarios into datasets that can be used to train a model. The transformation includes the generation of synthetic data that simulates real-world applications; this enables the model to learn and adapt more effectively within its operational parameters. In one embodiment, this may include a process that provides additional or more nuanced instructions as context for the purpose, intended use, or functions performed by a trained model
this may assist in focusing the process of developing training data on specific use cases or capabilities of a model.

An overview of the process flow for this phase may include:
Synthetic Data Creation:
   Controller's Action—based on the scenario list (after any refinement or filtering, as examples), the Controller directs the generation of synthetic data that embodies these scenarios. This includes detailed simulations or reconstructions of realistic situations which the model might encounter;
   LLM Prompt—“[Command, e.g., ‘Generate synthetic data for the following training scenarios], [Domain model input, e.g., ‘Undergraduate Linear Algebra teacher’], [Scenario details, e.g., include detailed steps and variables involved in each scenario]. [Response format guidance, e.g., ‘Respond in YAML format based on the training data input type—such as Alpaca or Vicuna.’]”, where Alpaca and Vicuna were projects that used generative data to finetune a small model to siphon data (see https://github.com/tatsu-lab/stanford_alpaca);
Data Augmentation:
   Description—to enhance the robustness of the training data, additional variations of each scenario are created using data augmentation techniques. This better ensures that the model can handle slight variations in input and context;
   Action—employ techniques such as paraphrasing, numerical variation, or contextual modifications (as examples) to expand the dataset;
   LLM Prompt—“[Command, e.g., ‘Augment the following scenario data’], [Scenario input, e.g., ‘Complex Equation Solving’], [Response guidance, e.g., ‘Create variations that alter numbers, terms, and problem structure without changing the underlying concepts’] [Response format guidance, e.g., ‘Respond in YAML format based on the training data input type—such as Alpaca or Vicuna.’]”;

Instrumentation and evaluation of the generated training data is then performed. This phase focuses on enhancing the training data to increase its utility for the model's learning process. The stage involves applying techniques to instrument the data, ensuring it is optimized for better utilization by the model. These techniques may include enriching the data with additional metadata, indexing for quick retrieval, and preprocessing for improved machine understanding, as non-limiting examples.

An overview of the process flow for this phase may include:
Metadata Enrichment:
   Description—augment the training data with relevant metadata to provide additional context that can help the model to better understand the nuances of the data;
   Controller's Action—identify key metadata elements that can be associated with each training scenario, such as difficulty level, topic relevance, and expected learning outcomes;
   LLM Prompt—“[Command, e.g., ‘Generate metadata for the following training scenarios’], [Training data input], [Response format guidance, e.g., ‘Respond in YAML format including metadata elements such as tags, difficulty levels, and learning objectives.’]”;
   Example Output:
      scenario: “Linear Equation Setup”
      tags: [“Linear Equations”, “Setup”, “Algebra”]
      difficulty level: 7
Model Based Data Clustering,
   Description—after enriching the data with metadata, use clustering (K-means or Hierarchical clustering, as examples) to organize training data and scenarios into groups based on similarity in metadata such as difficulty levels, tags, and expected learning outcomes. This clustering facilitates prompt analysis (as illustrated in FIG. 1(e)) by helping to predict whether the small parameter model can handle a new prompt or should forward it to a more capable model.

A phase involving the preparation of model evaluation cases is then executed (a portion of this process is illustrated in FIG. 1(e). This phase focuses on evaluating the scenarios to generate a comprehensive array of test cases to evaluate the model.

An example process flow for this phase may include:
Generation of Test Cases
   Controller's Action—the Controller initiates the generation of test cases by sending specific directives to the LLM (which is a larger and differently trained model than the small parameter AI model disclosed herein). These directives include the domain of interest and the types of scenarios the small parameter model should handle;
   LLM Prompt—“[Command, e.g., ‘Generate test cases], [Domain model input, e.g., ‘Undergraduate Linear Algebra Teacher’], [Response guidance, e.g., ‘Each test case should include a prompt and the expected output.’] [Response format guidance, e.g., ‘Respond in YAML including prompt and expected output]”;
   Expected Output:
      prompt: “Explain why the determinant is zero when a matrix has linearly dependent rows.”
      expected output: “The determinant of a matrix or zero if its rows are linearly dependent because this indicates that the matrix does not have full rank and therefore is not invertible.”

The small parameter model is then evaluated. The disclosed and/or described approach

primarily focuses on the shaping of data, evaluating performance, and iterating to improve the training data. The next step of this is model evaluation, which is performed using a large language model (LLM).

An overview of the process flow for this phase may include:
Generation of Test Cases—in some embodiments, this process flow may be used to attach metadata in an automated way, as a challenge in finetuning models is precise knowledge about what it is trained on—including quality, completeness, and accuracy;
Controller's Action—the Controller initiates a test by iterating through all of the generated test cases, getting the answer, and then comparing the expectation against the actual result;
LLM Prompt—“[Command, e.g., Evaluate the following output of a language model for the given prompt], [Domain model input, e.g., ‘The role of an undergraduate Linear Algebra Teacher’], [Response guidance, e.g., Evaluate it using a 1 (worst)-10 (best) scale on following criteria, completeness, accuracy, quality, and adherence to role.’] [Response format guidance, e.g., ‘Respond in YAML including the metrics]”;
   Expected Output:
      completeness: 7
      accuracy: 9
      quality: 9
      adherence_to_role: 9

In some embodiments, a component of the disclosed and/or described “Train as you go” framework involves the dynamic assessment of incoming prompts and a strategic decision-making process regarding a model's response capabilities for that prompt. This process ensures that the model not only addresses immediate inquiries but also continuously adapts and expands its knowledge base. FIG. 1(e) is a flow diagram illustrating a set of processes, operations, or functions that may be used as part of prompt analysis and adaptive forwarding to generate and use a set of training data for a model, in accordance with an embodiment of the disclosure.

An overview of the process flow for this prompt analysis and adaptive forwarding phase may include the following:
Controller's Action—the Controller monitors incoming prompts to determine their complexity and relevance by performing distance and similarity checks against the existing training dataset. If a prompt is relatively rare or “unseen”, it is forwarded to a more capable LLM for processing. Concurrently, the prompt is placed in a queue for further analysis to determine if it should be included in the next training data set update;
Prompt Queue Analysis—
   Pop off queue—regularly, the Controller reviews the queue to analyze each prompt;
   Relevance Check—determines if a prompt is relevant and reflects a real-world scenario the model needs to handle;
   Resource Documentation Check—before scenario creation, verifies if existing resource documentation adequately covers the topic of the prompt. If not, initiate the creation of new resource documentation;
   Scenario Generation—if no current scenario or documentation covers the prompt, create a new scenario that encapsulates the query. This step involves defining the scenario parameters, expected outcomes, and any specific conditions or constraints;
   Training Data Assessment—evaluate whether there is existing training data that supports the new scenario. If absent, proceed to generate or collect appropriate training data.

### Instruction Generation

In some embodiments, the disclosed approach includes a process for translating a resource or resources into actionable fine-tuning instructions. Using specialized language models (such as but not limited to or requiring use of llama 3.2 as an example), this efficiently turns documentation into sets of prompts and answers, or other format suitable for use in fine-tuning. This better ensures that a model is trained with precision for a specific vertical. As non-limiting examples, in some embodiments, such an Instruction Pipeline may perform or execute the following processes, functions, or operations:
Input Source(s):
   The pipeline receives “comprehensive resources”, which could be datasets or documentation related to a specific topic or vertical;
Translation into Fine-Tuning Instructions:
   A goal is to extract meaningful instruction sets from these resources. These instruction sets are essentially pairs of prompts and potential answers or outputs;
Use of Specialized Language Models:
   The pipeline leverages LLMs to process and understand the content of the resources. In some cases, these models have previously been fine-tuned on similar data or represent domain expertise to interpret and translate the content correctly;
Output Generation:
   An output of this process is one or more sets of prompts and answers. For example, if the comprehensive resource is a document about animal biology, the model might generate prompts such as “What is the primary diet of a lion?” with answers such as “meat”;
   Besides the Q&A format, the pipeline can convert data into other formats suitable for fine-tuning models. This could include potential scenarios, data points, or logical sequences, examples of creative thinking, deep reasoning, or capable of exploring a concept or situation, as non-limiting examples;
Precision and Vertical Specialization:
   The converted instructions ensure that subsequent models, when trained, understand the nuances and depths of their specific domain or vertical. As an example, a model focused on financial analysis would understand market dynamics, while another trained-on pediatrics would be adept at child healthcare nuances.

### Model Generation

The model generation process takes the fine-tuning instructions and applies them to a base model, such as those licensed from Hugging Face. Utilizing tools such as PyTorch, the base model is capable of creating more specialized models that are nimble, yet powerful. These techniques may include fine-tuning, and similar techniques used in model development. Continuous evaluations, both automated and human-assisted, are expected to lead to iterative improvements, making these models adaptable and resilient. The system checks the performance of the models after each update or iteration, using a feedback cycle in which an LLM is used to evaluate or score the results.

As one example, consider the training of a model to provide empathetic communication to a user (who may be a patient, service provider, or relative of the patient). This is performed manually at present, where a person “talks” to the model and goes through a series of types of conversations. In either manual or automated generation, the model and its performance may be evaluated for accuracy and/or completeness. This may include scoring of a portion of a conversation for one or more of completeness, accuracy, quality, and/or adherence_to_role (with each scored on a specific range).

The disclosed and/or described processes may be incorporated into multiple embodiments, some of which may include human input and/or proprietary refinements. As non-limiting examples:
Resource Data—responsible for the generation and constant curation of expert level resources, producing a set of resource data (in one sense, a controlled version of wikipedia/github);
   This may utilize generative AI techniques to create/generate desired content;
   This may include use of retrieval augmented generation (RAG) to enhance identified data or information;
Instructions—responsible for the processing of resource data generated by the resource data pipeline into fine tuning parameters. These instruction sets are similar to jsonl (Json lines) files that capture pairs of prompts and responses. For example:
   {prompt: what's the capital of Michigan, answer: Lansing};
Model generation—responsible for gathering instructions into a fine-tuning file, fine tuning a model, generating or using an evaluation set, and evaluating the model to discover gaps using the disclosed/described pipelines. A pipeline or process flow would typically be executed continuously and iteratively to keep it up to date, evaluate gaps, incorporate new proprietary data, expand the model, and update a base model.

As a non-limiting example, for a multi-functional task, the model development process could be described as follows:
Problem—design and launch a new smart home device that allows users to control both lighting and music in their homes through voice commands. This could be performed using a specialized Bots team:
   Market Research Bot (MRB)—specialized in gathering and analyzing market trends, user reviews, and competitive products;
   Design and Prototyping Bot (DPB)—expert in converting conceptual ideas into design sketches and basic prototypes;
   Sound Engineering Bot (SEB)—proficient in understanding acoustics and music quality;
   Natural Language Processing Bot (NLPB)—specialized in voice recognition and understanding human commands;
   Manufacturing and Logistics Bot (MLB)—knowledgeable in manufacturing processes, material sourcing, and delivery logistics.
Example processing Flow:
   MRB starts by analyzing the current market trends for smart home devices. It gathers user reviews, feedback, and lists top competitors. MRB then provides insights into preferred features, common complaints, and market gaps;
   Using the data from MRB, DPB sketches an initial design of the device, considering aesthetic appeal, user-friendliness, and functionality. It creates a 3D prototype and shares it with the team;
   SEB steps in to ensure that the device's sound output is of sufficient quality. It recommends speakers, optimizes their positioning for best acoustics, and suggests adjustments to DPB's design if needed;
   NLPB designs the voice recognition system. It gathers voice samples, fine-tunes its algorithms to understand and process voice commands such as “Play jazz music” or “Dim the lights to 50%”; and
   Once the design is finalized and the voice systems are in place, MLB takes over. It sources the best materials for manufacturing, identifies potential manufacturing partners, and plans the logistics for product delivery to various regions.
      Throughout this process, the bots collaborate and share their findings and progress, ensuring that all aspects of the project are cohesive and aligned. The result is that in a fraction of the traditional time required, the example bots can develop a comprehensive plan and prototype for the smart home device, tailored to market needs, ensuring acceptable sound quality, efficient voice recognition capabilities, and a (hopefully) seamless manufacturing process. The collaboration of the specialized bots provides an efficient and informed approach to developing a solution to a multifaceted problem.

As shown in the figures and as disclosed and/or described herein, the disclosed approach takes a prompt, breaks it down into an array of required topics (in one sense, this is accomplished by “asking” LLMs a question of what it takes to train an “expert” for that task), and then generates resources in the form of documents using large language models (LLMs) and proprietary data. These documents are effectively a form of handbook describing how to perform or learn to perform a specific task and may include subject matter expert knowledge about the task.

The documents or resources are then processed and used to generate training data for a small parameter LLM model. The model is then trained and evaluated to determine if additional resources and/or training data are needed. Further, as disclosed and/or described herein, in one embodiment, this may include a process that provides additional or more nuanced instructions as context for the purpose, intended use, or functions performed by a trained model—this may assist in focusing the process of developing training data on specific use cases or capabilities of a model.

In one embodiment, a resource generation process (as suggested by FIGS. 1(a), 1(b), and 1(c)) may perform or execute the following steps, stages, functions, or operations:
Initial Prompting—starting with a broad input or task, such as “how to be an Executive Coach”, the system identifies various related sub-topics;
Sub-topic Generation—derived from the broad input, sub-topics such as “the art of co-active coaching” or “leadership communication techniques” are identified;
Resource Generation—for each identified sub-topic, the system creates detailed resources. It utilizes both generative AI techniques, large language models (LLMs) for general knowledge, and may use proprietary data for specialized or exclusive content;
Data Integration—the system seamlessly combines information sourced from LLMs with proprietary data to craft comprehensive and relevant documents for each sub-topic.
   After the resource documents are identified, generated, or created, they may be classified for easier search and usage. An end result of this is a resource document with a flexible set of feature rich metadata that describes things about it, such as the type of information, how much information, the quality, or the level of complexity of the information, as non-limiting examples.

Language model “hallucination” refers to instances where a model produces outputs that aren't grounded in reality; the outputs are factually incorrect and obtained by the model filling in holes with things it “thinks” are likely/plausible. To address this potential source of error, one can use another model with more diverse data and question that model, followed by applying a certainty score value of the second model as a threshold for accepting the output of the possibly hallucinating model. Consensus or agreement doesn't necessarily indicate correctness, but this way of checking the output of the first model assists in evaluating it.

In some embodiments, an iterative process may be utilized to perform model evaluation. Evaluation in this sense is typically performed in one or more of the following ways:
With a validation set, which is essentially where data is split into two sets, a training set and a validation set, and the operator makes sure a model can perform well given the validation set scenarios;
A second approach for evaluation is to use a human/expert to perform a complex task and ask the language model to do the same, and then use a different language model to compare the results from the first model against the desired result obtained by the expert;
   If there are gaps/mistakes, the model being developed is asked to generate resources it needs to improve performance, generate those resources, create new instruction sets, and retrain the model;
A third possible approach is to check during model execution if a particular use case has been covered sufficiently, and “flag” that situation if not covered sufficiently;
   As an example, if a user is using a model for inference and they're frustrated, or they report it, then one would assume that “the model probably doesn't know this or isn't good at it”;
      If someone is using a model to write code, and the language model fails to understand how to use a particular software package, the user might become frustrated;
      A model might be able to use sentiment analysis to identify the user's frustration and then evaluate it and understand that the model did not adequately cover this topic, identify source data, and then finetune the model to improve its knowledge and capabilities.

If a gap is identified, then the disclosed and/or described process flow may repeat the breadth+depth+resource generation+instruction training portions of the flow and retrain the model. Regarding training of a model, in one embodiment, the process may use a base model (such as llama-2), gather a training and validation set from the generated and/or curated resources, train the model, and then evaluate it for gaps (which may be “closed” using an iterative feedback loop).

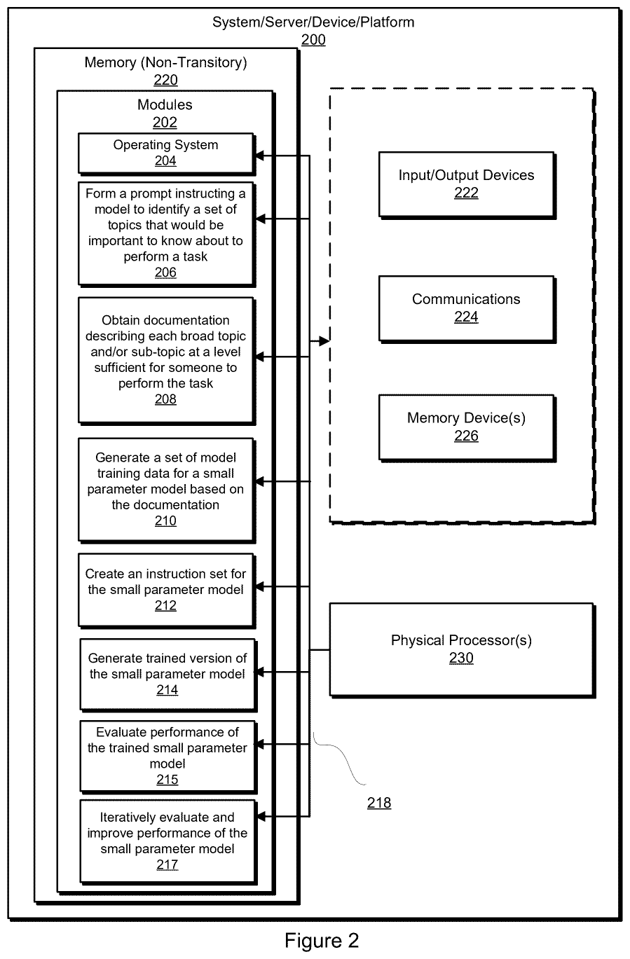

FIG. 2 is a diagram illustrating elements or components that may be present in a device, apparatus, server, platform, or system configured to implement a method, process, function, or operation in accordance with an embodiment of the disclosure. As shown in the figure and as mentioned, in some embodiments, the disclosed system and methods may be implemented in the form of an apparatus that includes an electronic processing element and a set of computer-executable instructions. The executable instructions may be stored in (or on) a non-transitory memory or data storage element and be part of a software application arranged into a software architecture.

In general, an embodiment may be implemented using a set of software instructions that are executed by a suitably programmed processing element (such as a GPU, CPU, TPU, QPU, state machine, microprocessor, processor, co-processor, or controller, as non-limiting examples). In a complex application or system such instructions are typically arranged into “modules” or “submodules” with each such module or submodule typically performing a specific task, process, function, or operation. The entire set of modules and submodules may be controlled or coordinated in their operation by an operating system (OS) or other form of organizational platform.

Each application module or submodule may correspond to a particular function, method, process, or operation that is implemented by the module or submodule. Such function, method, process, or operation may include those used to implement one or more aspects of the disclosed and/or described systems and methods.

The application modules and/or submodules may include suitable computer-executable code or a set of instructions (e.g., as would be executed by a suitably programmed processor, microprocessor, co-processor, or CPU, as examples), such as computer-executable code corresponding to a programming language. For example, programming language source code may be compiled into computer-executable code. Alternatively, or in addition, the programming language may be an interpreted programming language such as a scripting language.

Modules (or submodules) may contain one or more sets of instructions for performing a method or function described with reference to the Figures, and the descriptions or disclosure of the functions and operations provided in the specification. These modules may include those illustrated but may also include a greater number or fewer number than those illustrated.

A module or submodule may contain instructions that are executed by a processor contained in more than one of a server, apparatus, client device, network element, system, platform, or other component. In some embodiments, a plurality of electronic processors, each part of a separate device, apparatus, server, platform, or system may be responsible for executing all or a portion of the software instructions contained in an illustrated module or submodule. Thus, although FIG. 2 illustrates a set of modules which taken together perform multiple functions or operations, these functions or operations may be performed by different devices or system elements, with certain of the modules (or instructions contained in those modules) being associated with those devices or system elements.

As shown in FIG. 2, system 200 may represent a server or other form of computing or data processing system, platform, apparatus, or device. Modules 202 each contain a set of executable instructions, where when the set of instructions is executed by a suitable electronic processor or processors (such as that indicated in the figure by “Physical Processor(s) 230”), system (or server, platform, apparatus, or device) 200 operates to perform a specific process, operation, function, or method.

Modules 202 are stored in (or on) a non-transitory memory 220, which typically includes an Operating System module 204 that contains instructions used (among other functions) to access and control the execution of the instructions contained in other modules. The modules 202 stored in memory 220 are accessed for purposes of transferring data and executing instructions by use of a “bus” or communications line 218, which also serves to permit processor(s) 230 to communicate with the modules for purposes of accessing and executing a set of instructions.

Bus or communications line 218 also permits processor(s) 230 to interact with other elements of system 200, such as input or output devices 222, communications elements 224 for exchanging data and information with devices external to system 200, and additional memory devices 226. Each module or sub-module may contain a set of computer-executable instructions that when executed by a programmed processor or co-processors cause the processor or co-processors (or a device, apparatus, or other component in which they are contained) to perform a specific function, method, process, or operation.

With reference to FIG. 2, in some embodiments, the implemented steps, stages, elements, components, functions, methods, processes, or operations may include those used to perform one or more aspects of the disclosed and/or described system and methods, such as for:
Form a prompt instructing a model (such as an LLM) to identify a set of topics that would be important for a person to know about to perform a task or achieve a specific end-result (as suggested by module 206);
   This may include identifying broad topics and more specific sub-topics of information believed needed to perform the task or achieve the end result;
Obtain relevant documentation describing each broad topic and/or sub-topic at a level sufficient for someone to perform the task or achieve the end result (as suggested by module 208);
   This may include one or more articles, manuals, how-to descriptions, explanations generated by experts, definitions, or text generated from an image, video or audio, as non-limiting examples;
   A curation pipeline may be used to refine the set of resources by incorporating “expert” knowledge to select, modify, or discard a resource;
Generate a set of model training data for a small parameter model based on the documentation (as suggested by module 210);
Create an instruction set for the small parameter model (for example, from the output of a LLM that is used to process the documentation) (as suggested by module 212);
   In some embodiments, the generated instruction set or sets may include instructions for one or more of training, validation, or evaluation of a small parameter model;
   In one embodiment, the instruction set or sets may take the form of If-Then statements;
Generate a trained version of the small parameter model (as suggested by module 214);
   This typically comprises use of the training and validation instruction sets, in conjunction with the model training data;
Evaluate the performance of the trained small parameter model (as suggested by module 215);
   This typically comprises use of the evaluation instruction set to evaluate performance of the trained model and in some cases identify topics or sub-topics where additional resources would be beneficial to obtain and utilize;
Iteratively evaluate and improve performance of the small parameter model (as needed) (as suggested by module 217);
   This typically involves using the result of evaluating the trained model to decide if further resources are needed, and if so, returning control to a resource pipeline to identify additional resource documents, followed by creation of further training data, (re)training a model, and (re)evaluating the model.

As mentioned, in some embodiments, the systems and methods disclosed and/or described herein may provide services through a Software-as-a-Service (Saas) or multi-tenant platform. The platform provides access to multiple entities, each with a separate account and associated data storage. Each account may correspond to a specific task, a category of tasks, a source of information, a set of sources or resources relevant to a task or category of tasks, a domain or sub-domain in which the disclosed small parameter model may be used, or an organization, as non-limiting examples. Each account may access one or more services or applications, a set of which are instantiated in their account, and which implement one or more of the methods, processes, operations, or functions disclosed and/or described herein.

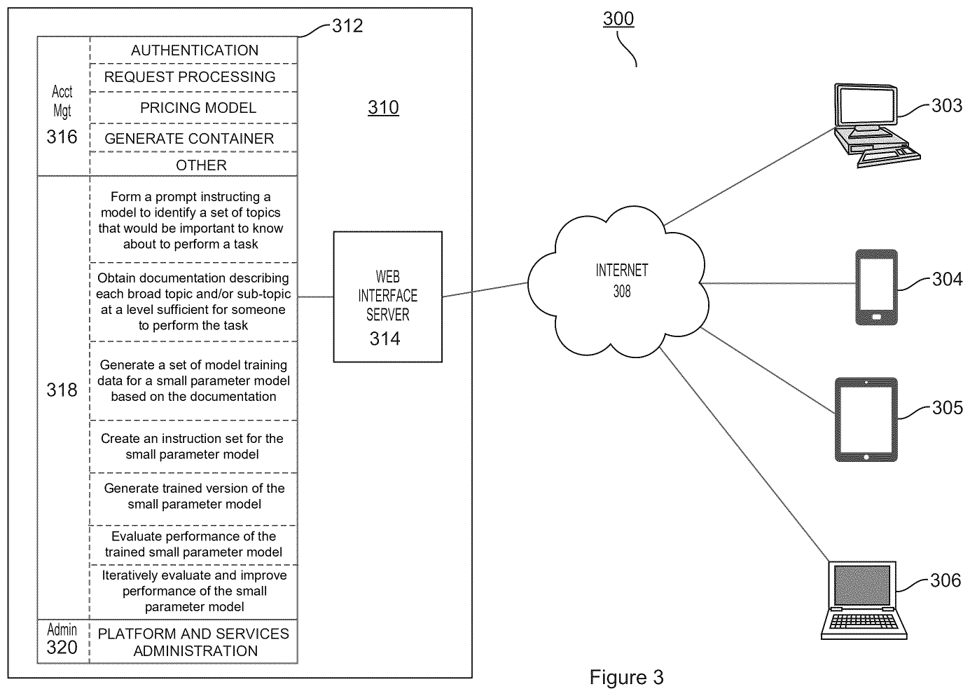

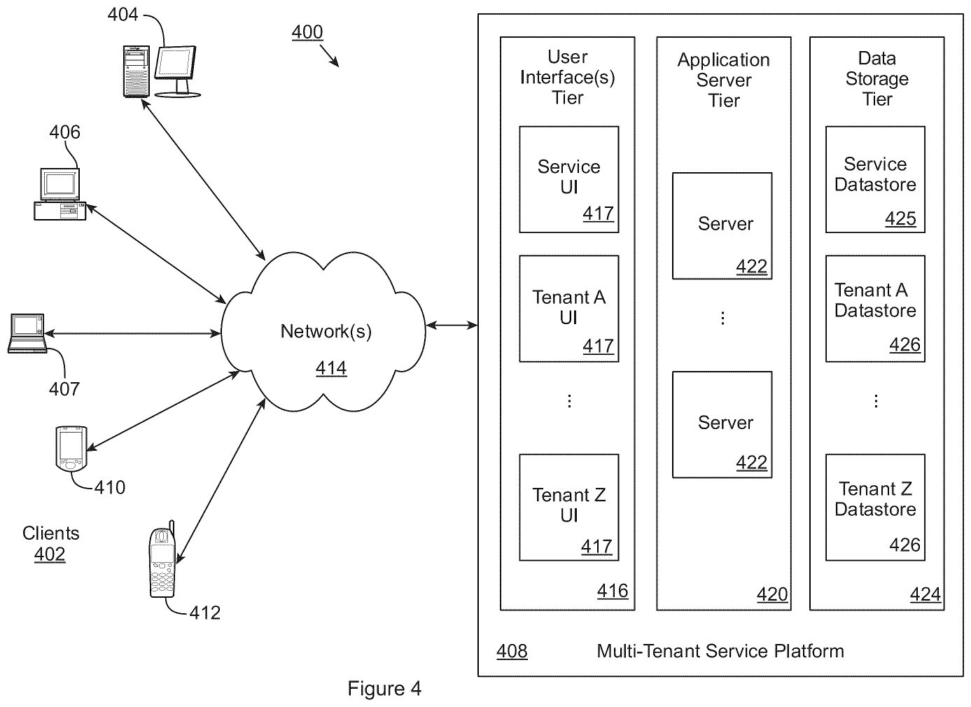

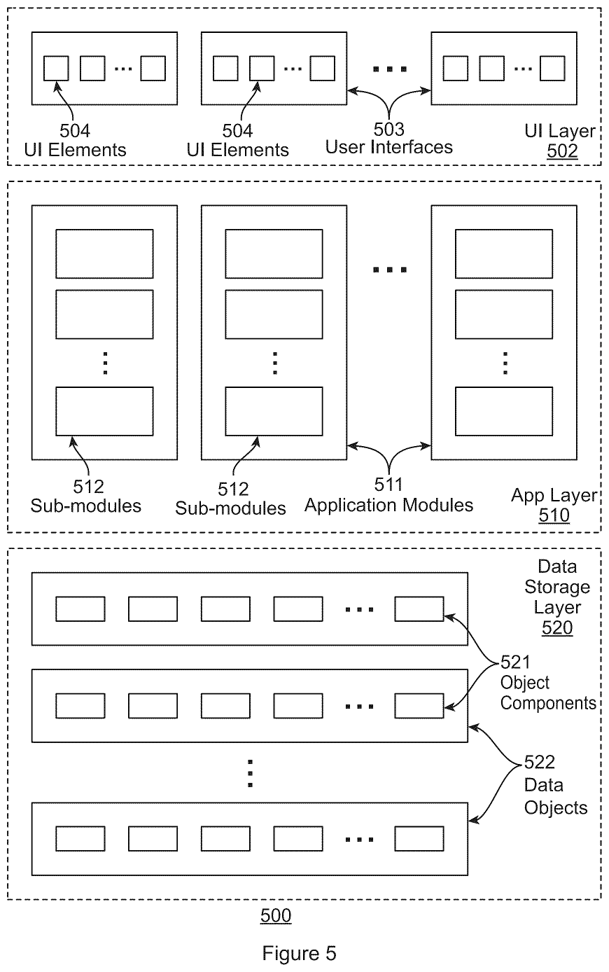

FIG. 3 is a diagram illustrating a SaaS system in which an embodiment of the disclosure may be implemented. FIG. 4 is a diagram illustrating elements or components of an example operating environment in which an embodiment of the disclosure may be implemented. FIG. 5 is a diagram illustrating additional details of the elements or components of the multi-tenant distributed computing service platform of FIG. 4, in which an embodiment of the disclosure may be implemented.

In some embodiments, the system or service(s) disclosed and/or described herein may be implemented as micro-services, processes, workflows, or functions performed in response to requests. The micro-services, processes, workflows, or functions may be performed by a server, data processing element, platform, or system. In some embodiments, the services may be provided by a service platform located “in the cloud”. In such embodiments, the platform is typically accessible through APIs and SDKs.

Services and functionality of the disclosed and/or described system architecture and associated processing flow(s) for creating and improving a specialized form of model having fewer parameters and requiring fewer resources to train may be provided as micro-services within the platform for each of multiple users or accounts. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide services and functionality for creating and improving a specialized form of large language model having fewer parameters and requiring fewer resources to train, as disclosed and/or described herein.

Although in some embodiments, a platform or system of the type illustrated in FIGS. 3-5 may be operated by a 3^{rd} party provider, in other embodiments, the platform may be operated by a provider and a different source may provide applications or services for users through the platform.

FIG. 3 is a diagram illustrating a system 300 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, or organizations, as non-limiting examples. In general, a client device having access to the Internet may be used to provide a request for a service. Users interface with the service platform across the Internet 308 or another suitable communications network or combination of networks. Non-limiting examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. Either or both of services 312 and the web interface server 314 may be implemented on one or more different hardware systems and components, even though represented as singular units in FIG. 3.

Services 312 may include one or more functions, processes, or operations for identifying resources, curating resources, generating training data based on the resources, creating one or more instruction sets from output(s) of a LLM or LLMs, generating a trained model, evaluating the trained model, and iteratively improving the model (which may include curating the resources and identifying additional resources).

In some embodiments, the set of applications or services available to a user may include one or more that perform the functions and methods disclosed and/or described herein. As examples, in some embodiments, the set of applications, functions, processes, operations or services made available through the platform or system 310 may include:
account management services 316, such as (as non-limiting examples):
   a process or service to authenticate a person or entity requesting the creation of a small parameter model for a specific task (such as credentials, proof of purchase, or verification that the customer has been authorized by a company to use the services provided by the platform);
   a process or service to receive a request for the creation of a small parameter model for a specific task or to achieve a specific goal;
   an optional process or service to generate a price for the requested service or a charge against a service contract;
   a process or service to generate a container or instantiation of the requested processes for a user/customer, where the instantiation may be customized for a particular company; and
   other forms of account management services;
a set of processes or services 318 for the creation of a small parameter LLM for a specific task, such as a process or service for:
   Form a prompt instructing a model (such as an LLM) to identify a set of topics that would be important for a person to know about to perform a task or achieve a specific end-result;
      This may include identifying broad topics and more specific sub-topics of information believed needed to perform the task or achieve the end result;
   Obtain relevant documentation describing each broad topic and/or sub-topic at a level sufficient for someone to perform the task or achieve the end result;
      This may include one or more articles, manuals, how-to descriptions, explanations generated by experts, definitions, or text generated from an image, video or audio, as non-limiting examples;
      A curation pipeline may be used to refine the set of resources by incorporating “expert” knowledge to select, modify, or discard a resource;
   Generate a set of model training data for a small parameter model based on the documentation;
   Create an instruction set for the small parameter model (for example, from the output of a LLM that is used to process the documentation);
      In some embodiments, the generated instruction set or sets may include instructions for one or more of training, validation, or evaluation of a small parameter model;
      In one embodiment, the instruction set or sets may take the form of If-Then statements;
   Generate a trained version of the small parameter model;
      This typically comprises use of the training and validation instruction sets, in conjunction with the model training data;
   Evaluate the performance of the trained small parameter model;
      This typically comprises use of the evaluation instruction set to evaluate performance of the trained model and in some cases identify topics or sub-topics where additional resources would be beneficial to obtain and utilize;
   Iteratively evaluate and improve performance of the small parameter model (as needed);
      This typically involves using the result of evaluating the trained model to decide if further resources are needed, and if so, returning control to a resource pipeline to identify additional resource documents, followed by creation of further training data, (re) training a model, and (re) evaluating the model;
administrative services 320, such as
   a process or services to enable the provider of the small parameter model for a specific task service and/or the platform to administer and configure the processes and services provided to users.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server (as examples).

FIG. 4 is a diagram illustrating elements or components of an example operating environment 400 with which an embodiment of the disclosure may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented or executed at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components (e.g., one or more electronic processors, microprocessors, central processing units (CPU), or controllers). Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application or service, or causing the execution of specific data processing operations, as non-limiting examples.

Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with a suitable data storage technology, including but not limited to structured query language (SQL) based relational database management systems (RDBMS).

Service Platform 408 may be multi-tenant and may be operated by an entity to provide multiple tenants with a set of business-related or other data processing applications or services, data storage, and functionality. For example, the applications and functionality may include providing web-based access to the functionality used by a business to provide services to end-users, thereby allowing a user with a browser and an Internet or intranet connection to view, enter, process, or modify certain types of information.

Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than building and maintaining such a platform or system themselves, a business may utilize a platform or system provided by a third party. A third party may implement a business system/platform as described in the context of a multi-tenant platform, where individual instantiations of a business' data processing workflow (such as the architecture and processes for the creation of a small parameter model for a specific task disclosed and/or described herein) are provided to users, with each business representing a tenant of the platform. One advantage to such multi-tenant platforms is the ability for each tenant to customize their instantiation of a data processing workflow to that tenant's specific business needs or operational methods. Further, each tenant may be a business or entity that uses the multi-tenant platform to provide services and functionality to multiple users.

FIG. 5 is a diagram illustrating additional details of the elements or components of the multi-tenant distributed computing service platform of FIG. 4, with which an embodiment of the disclosure may be implemented. In general, an embodiment may be implemented using a set of software instructions that are executed by a suitably programmed processing element (such as a CPU, microprocessor, processor, controller, or computing device). In a complex system such instructions are typically arranged into “modules” with each such module performing a specific task, process, function, or operation. The entire set of modules may be controlled or coordinated in their operation by an operating system (OS) or other form of organizational platform.

The example architecture 500 of a multi-tenant distributed computing service platform illustrated in FIG. 5 includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture.

Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more associated sub-modules 512. Each application module 511 or sub-module 512 may correspond to a function, method, process, or operation that is implemented by the module or sub-module (e.g., a function or process related to providing data processing and other services to a user of the platform). Such function, method, process, or operation may include those used to implement one or more aspects of the disclosed system and methods, such as for one or more of the processes or functions disclosed and/or described with reference to the specification and Figures:
Form a prompt instructing a model (such as an LLM) to identify a set of topics that would be important for a person to know about to perform a task or achieve a specific end-result;
   This may include identifying broad topics and more specific sub-topics of information believed needed to perform the task or achieve the end result;
Obtain relevant documentation describing each broad topic and/or sub-topic at a level sufficient for someone to perform the task or achieve the end result;
   This may include one or more articles, manuals, how-to descriptions, explanations generated by experts, definitions, or text generated from an image, video or audio, as non-limiting examples;
   A curation pipeline may be used to refine the set of resources by incorporating “expert” knowledge to select, modify, or discard a resource;
Generate a set of model training data for a small parameter model based on the documentation;
Create an instruction set for the small parameter model (for example, from the output of a LLM that is used to process the documentation);
   In some embodiments, the generated instruction set or sets may include instructions for one or more of training, validation, or evaluation of a small parameter model;
   In one embodiment, the instruction set or sets may take the form of If-Then statements;
Generate a trained version of the small parameter model;
   This typically comprises use of the training and validation instruction sets, in conjunction with the model training data;
Evaluate the performance of the trained small parameter model;
   This typically comprises use of the evaluation instruction set to evaluate performance of the trained model and in some cases identify topics or sub-topics where additional resources would be beneficial to obtain and utilize;
Iteratively evaluate and improve performance of the small parameter model (as needed);
   This typically involves using the result of evaluating the trained model to decide if further resources are needed, and if so, returning control to a resource pipeline to identify additional resource documents, followed by creation of further training data, (re)training a model, and (re)evaluating the model.

The application modules and/or sub-modules may include a suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjointed or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjointed or overlapping.

Note that the example computing environments depicted in FIGS. 3-5 are not intended to be limiting examples. Further environments in which an embodiment may be implemented in whole or in part include devices (including mobile devices), software applications, systems, apparatuses, networks, SaaS platforms, laaS (infrastructure-as-a-service) platforms, or other configurable components that may be used by multiple users for data entry, data processing, application execution, or data review (as non-limiting examples).

Embodiments as disclosed and/or described herein can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

In some embodiments, certain of the methods, models or functions disclosed and/or described herein may be embodied in the form of a trained neural network, where the network is implemented by the execution of a set of computer-executable instructions and/or is represented by a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform.

A trained neural network, trained machine learning model, or other form of decision or classification process may be used to implement one or more of the methods, functions, processes, or operations disclosed and/or described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in an assortment of representative input patterns that are associated with their intended output response. Training iteratively determines the weights for intermediate and final feature neurons. In terms of a computational model, each neuron calculates the dot product of inputs and weights, adds the bias, and applies a non-linear trigger or activation function (for example, using a sigmoid response function).

Machine learning (ML) is being used in multiple industries and contexts to enable the analysis of data and assist in making decisions. To benefit from using machine learning, a machine learning algorithm is applied to a set of training data and labels to generate a “model” which represents what the application of the algorithm has “learned” from the training data. Each element (or example, in the form of one or more parameters, variables, characteristics or “features”) of the set of training data is associated with a label or annotation that defines how the element should be classified by the trained model. A machine learning model is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

This disclosure includes the following embodiments and clauses:
1. A method of creating a model to perform a task, comprising:
   forming a prompt for a model, the prompt instructing the model to identify a set of topics that would be important to know about to perform a task;
   inputting the prompt into the model to output the set of topics;
   based on the set of topics, obtaining documentation describing each topic identified by the model at a level sufficient for someone to perform the task;
   generating a set of training data for a small parameter model based at least in part on the obtained documentation;
   creating an instruction set for the small parameter model;
   generating a trained version of the small parameter model;
   evaluating performance of the trained small parameter model; and
   iteratively continuing to evaluate and improve the performance of the small parameter model.
2. The method of clause 1, wherein the model instructed by the prompt is a large language model (LLM) and the LLM output includes broad topics and sub-topics of information believed needed to perform the task.
3. The method of clause 1, wherein the documentation includes one or more of articles, manuals, how-to descriptions, explanations generated by experts, definitions, instructions, or text generated from a video or audio.
4. The method of clause 1, wherein iteratively continuing to evaluate and improve the performance of the small parameter model further comprises using a result of evaluating the performance of the trained small parameter model to decide if further resources are needed, and if so, returning control to a resource pipeline to identify additional documentation, followed by creation of further training data for the small parameter model, retraining the small parameter model, and reevaluating the small parameter model.
5. The method of clause 1, wherein the instruction set for the small parameter model is one or more of a training, a validation, or an evaluation instruction set.
6. The method of clause 5, wherein the instruction set is generated by a model used to process the documentation.
7. The method of clause 5, wherein the instruction set is in the form of a set of If-Then statements.
8. The method of clause 1, wherein the task is one of executive coaching, specialized care management, language education for children, character consistency, character generation, or financial analysis.
9. A system, comprising:
   one or more electronic processors configured to execute a set of computer-executable instructions; and
   the set of computer-executable instructions stored in one or more non-transitory computer-readable media, wherein when executed, the instructions cause the one or more electronic processors to
      form a prompt for a model, the prompt instructing the model to identify a set of topics that would be important to know about to perform a task;
      input the prompt into the model to output the set of topics;
      based on the set of topics, obtain documentation describing each topic identified by the model at a level sufficient for someone to be able to perform the task;
      generate a set of training data for a small parameter model based at least in part on the obtained documentation;
      create an instruction set for the small parameter model;
      generate a trained version of the small parameter model;
      evaluate performance of the trained small parameter model; and
   iteratively continue to evaluate and improve the performance of the small parameter model.
10. One or more non-transitory computer-readable media including a set of computer-executable instructions that when executed by one or more programmed electronic processors, cause the processors to:
   form a prompt for a model, the prompt instructing the model to identify a set of topics that would be important to know about to perform a task;
   input the prompt into the model to output the set of topics;
   based on the set of topics, obtain documentation describing each topic identified by the model at a level sufficient for someone to be able to perform the task;
   generate a set of training data for a small parameter model based at least in part on the obtained documentation;
   create an instruction set for the small parameter model;
   generate a trained version of the small parameter model;
   evaluate performance of the trained small parameter model; and
   iteratively continue to evaluate and improve the performance of the small parameter model.

Any of the software components, processes or functions disclosed and/or described herein may be implemented as software code to be executed by a processor using a suitable computer language such as Python, Java, Javascript, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is a medium suitable for the storage of data or an instruction set aside from a transitory waveform. Such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar device or form of memory based on similar technologies. Such computer-readable storage media allow the processing element or processor to access computer-executable process steps or application programs, stored on removable and non-removable memory media, to off-load data from a device or to upload data to a device. As mentioned, with regards to the embodiments disclosed and/or described herein, a non-transitory computer-readable medium may include almost any structure, technology, or method apart from a transitory waveform or similar medium.

One or more embodiments of the disclosure are described herein with reference to block diagrams of systems, and/or to flowcharts or flow diagrams of functions, operations, processes, or methods. One or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, or stages or steps may not need to be performed in the order presented or may not need to be performed at all.

The computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods disclosed and/or described herein. The computer-executable program instructions may be stored in (or on) a computer-readable memory that can direct a computer or other programmable data processing apparatus to function in a specific manner, such that the instructions stored in (or on) the computer-readable memory produce an article of manufacture including instruction means that implement one or more of the functions, operations, processes, or methods disclosed and/or described herein.

While embodiments of the disclosure have been described in connection with what is presently considered to be the most practical implementation, the disclosed and/or described approach is not limited to those embodiments. Instead, the disclosed and/or described embodiments are intended to cover various modifications and equivalent arrangements included within the scope of the appended claims. Although specific terms are employed herein, they are used in a generic and descriptive sense and not for purposes of limitation.

This written description includes one or more examples describing implementations of the disclosed approach to enable a person skilled in the art to practice one or more embodiments of the disclosure, including making and using a device or system and performing an incorporated method. The patentable scope of embodiments of the disclosure is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents cited herein are hereby incorporated by reference to the same extent as if each reference were individually and specifically indicated to be incorporated by reference and/or were set forth in its entirety herein.

The use of the terms “a” and “an” and “the” and similar references in the specification and in the claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Methods or processes disclosed and/or described herein may be performed in any suitable order unless otherwise indicated herein or clearly contradicted by context. The use of examples, or exemplary language (e.g., “such as”) herein is intended to illuminate embodiments of the disclosure and does not pose a limitation to the scope of the claims unless otherwise indicated. No language in the specification should be construed as indicating any non-claimed element as essential to each embodiment of the disclosure.

As used herein (i.e., the claims, figures, and specification), the term “or” is used inclusively to refer to items in the alternative and in combination.

Different arrangements of the components or operations illustrated in the drawings or disclosed and/or described herein, as well as components and steps not shown or explicitly described may be possible. Similarly, some features and sub-combinations may be useful and may be implemented without reference to other features and sub-combinations. Embodiments of the disclosure are described for illustrative and not for restrictive purposes, and alternative embodiments may be apparent. Accordingly, the disclosure is not limited to the embodiments described and/or illustrated in the drawings, and other embodiments and modifications may be made without departing from the scope of the claims.

That which is claimed is:

1. A method of creating a model to perform a task, comprising:
forming a prompt for a model, the prompt instructing the model to identify a set of topics that would be important to know about to perform a task;
inputting the prompt into the model to output the set of topics;
based on the set of topics, obtaining documentation describing each topic identified by the model at a level sufficient for someone to perform the task;
generating a set of training data for a small parameter model based at least in part on the obtained documentation;
creating an instruction set for the small parameter model;
generating a trained version of the small parameter model;
evaluating performance of the trained small parameter model; and
iteratively evaluate and improve the performance of the small parameter model.

2. The method of claim 1, wherein the model instructed by the prompt is a large language model (LLM) and the LLM output includes broad topics and sub-topics of information believed needed to perform the task.

3. The method of claim 1, wherein the documentation includes one or more of articles, manuals, how-to descriptions, explanations generated by experts, definitions, instructions, or text generated from a video or audio.

4. The method of claim 1, wherein iteratively continuing to evaluate and improve the performance of the small parameter model further comprises using a result of evaluating the performance of the trained small parameter model to decide if further resources are needed, and if so, returning control to a resource pipeline to identify additional documentation, followed by creation of further training data for the small parameter model, retraining the small parameter model, and reevaluating the small parameter model.

5. The method of claim 1, wherein the instruction set for the small parameter model is one or more of a training, a validation, or an evaluation instruction set.

6. The method of claim 5, wherein the instruction set is generated by a model used to process the documentation.

7. The method of claim 5, wherein the instruction set is in the form of a set of If-Then statements.

8. The method of claim 1, wherein the task is one of executive coaching, specialized care management, language education for children, character consistency, character generation, or financial analysis.

9. A system, comprising:
one or more electronic processors configured to execute a set of computer-executable instructions; and
the set of computer-executable instructions stored in one or more non-transitory computer-readable media, wherein when executed, the instructions cause the one or more electronic processors to
form a prompt for a model, the prompt instructing the model to identify a set of topics that would be important to know about to perform a task;
input the prompt into the model to output the set of topics;
based on the set of topics, obtain documentation describing each topic identified by the model at a level sufficient for someone to be able to perform the task;
generate a set of training data for a small parameter model based at least in part on the obtained documentation;
create an instruction set for the small parameter model;
generate a trained version of the small parameter model;
evaluate performance of the trained small parameter model; and
iteratively continue to evaluate and improve the performance of the small parameter model.

10. The system of claim 9, wherein the documentation includes one or more of articles, manuals, how-to descriptions, explanations generated by experts, definitions, instructions, or text generated from a video or audio.

11. The system of claim 9, wherein iteratively continuing to evaluate and improve the performance of the small parameter model further comprises using a result of evaluating the performance of the trained small parameter model to decide if further resources are needed, and if so, returning control to a resource pipeline to identify additional documentation, followed by creation of further training data for the small parameter model, retraining the small parameter model, and reevaluating the small parameter model.

12. The system of claim 9, wherein the instruction set for the small parameter model is one or more of a training, a validation, or an evaluation instruction set.

13. The system of claim 9, wherein the instruction set is generated by a model used to process the documentation, and further, the instruction set is in the form of a set of If-Then statements.

14. The system of claim 9, wherein the task is one of executive coaching, specialized care management, language education for children, character consistency, character generation, or financial analysis.

15. One or more non-transitory computer-readable media including a set of computer-executable instructions that when executed by one or more programmed electronic processors, cause the processors to:
form a prompt for a model, the prompt instructing the model to identify a set of topics that would be important to know about to perform a task;
input the prompt into the model to output the set of topics;
based on the set of topics, obtain documentation describing each topic identified by the model at a level sufficient for someone to be able to perform the task;
generate a set of training data for a small parameter model based at least in part on the obtained documentation;
create an instruction set for the small parameter model;
generate a trained version of the small parameter model;
evaluate performance of the trained small parameter model; and
iteratively continue to evaluate and improve the performance of the small parameter model.

16. The non-transitory computer-readable media of claim 15, wherein the documentation includes one or more of articles, manuals, how-to descriptions, explanations generated by experts, definitions, instructions, or text generated from a video or audio.

17. The non-transitory computer-readable media of claim 15, wherein iteratively continuing to evaluate and improve the performance of the small parameter model further comprises using a result of evaluating the performance of the trained small parameter model to decide if further resources are needed, and if so, returning control to a resource pipeline to identify additional documentation, followed by creation of further training data for the small parameter model, retraining the small parameter model, and reevaluating the small parameter model.

18. The non-transitory computer-readable media of claim 15, wherein the instruction set for the small parameter model is one or more of a training, a validation, or an evaluation instruction set.

19. The non-transitory computer-readable media of claim 15, wherein the instruction set is generated by a model used to process the documentation, and further, the instruction set is in the form of a set of If-Then statements.

20. The non-transitory computer-readable media of claim 15, wherein the task is one of executive coaching, specialized care management, language education for children, character consistency, character generation, or financial analysis.
